(19) United States
(12) Patent Application Publication
(10) Pub. No.: US 2024/0297948 A1
(43) Pub. Date: Sep. 5, 2024

(54) IMAGE PROCESSING DEVICE AND COMMUNICATION SYSTEM

(71) Applicant: KYOCERA CORPORATION, Kyoto-shi, Kyoto (JP)

(72) Inventors: Hiroshi OKA, Kyoto-shi, Kyoto (JP); Shigeki TAKAYA, Yokohama-shi, Kanagawa (JP); Hirofumi SUZUKI, Koka-shi, Shiga (JP); Hajime MATSUSHIMA, Kyoto-shi, Kyoto (JP); Kouichi MARUTA, Kirishima-shi, Kagoshima (JP)

(21) Appl. No.: 18/574,750

(22) PCT Filed: Jun. 29, 2021
(86) PCT No.: PCT/JP2021/024520

§ 371 Date: Dec. 28, 2023

(51) Int. Cl. H04N 1/44; H04N 1/00

(52) U.S. Cl. CPC H04N 1/442; H04N 1/00217; H04N 1/00244; H04N 1/4426; H04N 1/4433; H04N 2201/0094

(57) ABSTRACT

An image processing apparatus includes an image processing unit, a detection unit, a communication unit, and a control unit. The image processing unit includes at least one of a printer or a scanner. The detection unit detects user's biological information. The communication unit transmits data for authentication based on biological information detected by the detection unit and receives an authentication result of authentication using the data for authentication. The control unit gives an instruction to perform an action relevant to the image processing unit and the communication unit on the basis of the received authentication result.

### RELATED APPLICATIONS

The present application is a National Phase of International Application No. PCT/JP2021/024520 filed Jun. 29, 2021.

### TECHNICAL FIELD

The present disclosure relates to an image processing apparatus including at least one of a printer or a scanner and a communication system including the image processing apparatus.

### BACKGROUND OF INVENTION

An image processing apparatus that performs biometric authentication is known (see, for example, Patent Literature 1). The image processing apparatus described in Patent Literature 1 reads a fingerprint by a document reading device. A universal serial bus (USB) memory in which data of a fingerprint for verification is stored is connected to the image processing apparatus. The image processing apparatus performs authentication by comparing the read fingerprint and the fingerprint stored in the USB memory. When the authentication succeeds, the image processing apparatus permits a user to perform copying or facsimile (FAX) transmission.

### CITATION LIST

### Patent Literature

Patent Literature 1: Japanese Unexamined Patent Application Publication No. 2008-187269

### SUMMARY

### Problem to be Solved

In an aspect of the present disclosure, an image processing apparatus includes an image processing unit, a detection unit, a communication unit, and a control unit. The image processing unit includes at least one of a printer or a scanner. The detection unit detects user's biological information. The communication unit transmits data for authentication based on biological information detected by the detection unit and receives an authentication result of authentication using the data for authentication. The control unit gives an instruction to perform an action relevant to the image processing unit and the communication unit. The control unit gives the instruction to perform the action on the basis of the authentication result.

In an aspect of the present disclosure, a communication system includes an image processing apparatus and an external authentication apparatus. The image processing apparatus includes an image processing unit, a detection unit, a communication unit, and a control unit. The image processing unit includes at least one of a printer or a scanner. The detection unit detects user's biological information. The communication unit transmits data for authentication based on biological information detected by the detection unit. The control unit gives an instruction to perform an action relevant to the image processing unit and the communication unit. The external authentication apparatus receives the data for authentication from the image processing apparatus and performs authentication. The control unit gives the instruction to perform the action on the basis of an authentication result of the external authentication apparatus.

### BRIEF DESCRIPTION OF THE DRAWINGS

FIG. 1 is a schematic view illustrating an example of a communication system according to an embodiment.

FIG. 2 is a schematic view illustrating a hardware configuration related to a signal processing system of an image processing apparatus included in the communication system of FIG. 1.

FIG. 3 is a flowchart illustrating an outline of operation of the communication system of FIG. 1.

FIG. 4 is a block diagram for explaining a first example of an action based on an authentication result.

FIG. 5 is a flowchart for explaining the first example of the action based on the authentication result.

FIG. 6 is a flowchart for explaining a second example of an action based on the authentication result.

FIG. 7 is a block diagram for explaining a third example of an action based on the authentication result.

FIG. 8 is a schematic view illustrating an example of an image displayed on a display unit when authentication fails.

FIG. 9 is a schematic view illustrating an example of an event that triggers cancellation of authentication.

FIG. 10 is a flowchart illustrating an example of a procedure of processing related to cancellation of authentication.

FIG. 11 is a block diagram illustrating a use example of data related to authentication.

FIG. 12 is a flowchart illustrating a use example of data related to authentication.

FIG. 13 is a schematic view illustrating a variation of operation of registering data related to authentication.

FIG. 14 is a flowchart illustrating an example of a procedure of processing for registering data related to authentication.

FIG. 15 is a schematic view illustrating a specific example of a method for generating data related to authentication.

FIG. 16 is a perspective view illustrating a configuration of a part of an image processing apparatus that detects biological information.

FIG. 17 is a cross-sectional view illustrating a specific example of a detection unit that detects biological information by an ultrasonic wave.

FIG. 18 is a schematic view for explaining an operation mode of the detection unit that detects biological information.

FIG. 19 is a flowchart illustrating an example of a procedure of processing related to switching of an operation mode of the detection unit that detects biological information.

### DESCRIPTION OF EMBODIMENTS

An image processing apparatus according to the present embodiment is described below with reference to the drawings. Note that some terms generally have multiple meanings, as described below. Also in the description of the present embodiment, terms should be interpreted as appropriate in consideration of a context and the like.

The term “biological information”, for example, sometimes refers to information on a feature currently appearing in a human (information that does not depend on a detection method from another perspective), sometimes refers to raw information obtained by detecting the feature, sometimes refers to information on a feature amount extracted from the raw information, and sometimes refers to information obtained by processing the raw information or the information on the feature amount according to an intended purpose of use. The processed information is, for example, information obtained by encrypting the feature amount. In the description of the embodiment, the term “biological information” basically refers to information that has not been processed yet (e.g., raw information or information on a feature amount).

In relation to the above description, “data for authentication based on biological information” or “data for verification based on biological information” used in the present embodiment may be any of raw information, information on a feature amount, and information obtained by processing the raw information or the information on a feature amount.

The term “authentication” sometimes refers to an action of proving a target to be authentic and sometimes refers to a state where a target was or has been proven to be authentic by such an action. In relation to this, having been able to prove a target to be authentic is sometimes referred to as succeeding in authentication, and having been unable to prove a target to be authentic is sometimes expressed as failing in authentication.

The term “network” sometimes refers to a communication network and sometimes refers to a combination of a communication network and an apparatus connected to the communication network. The same applies to a term subordinate to the term “network”. Examples of the term subordinate to the term “network” include the Internet, a public network, a private network, a local area network (LAN), and a virtual private network (VPN).

The term “VPN” sometimes refers to a technique of virtually expanding a private network to a public network and sometimes refers to a network constructed by the technique. Note that the term “VPN” is sometimes added to a technical matter related to a VPN as appropriate. For example, connection established so that communication using a VPN is performed is sometimes referred to as VPN connection, and performing such connection is sometimes referred to as performing VPN connection.

The term “connection” sometimes refers to connection (connection in a narrow sense) established through authentication (e.g., three-way handshaking) and sometimes refers to connection (connection in a broad sense) simply meaning being communicable. Unlike the former connection, the latter connection can include, for example, the following: connection in such a sense that establishment of connection is prohibited although communication (e.g., broadcast and a response to this) before establishment of connection is permitted, connection in such a sense that any software (logical from another perspective) communication is prohibited although electric (physical from another perspective) connection is established by using a cable.

### (Outline of Communication System)

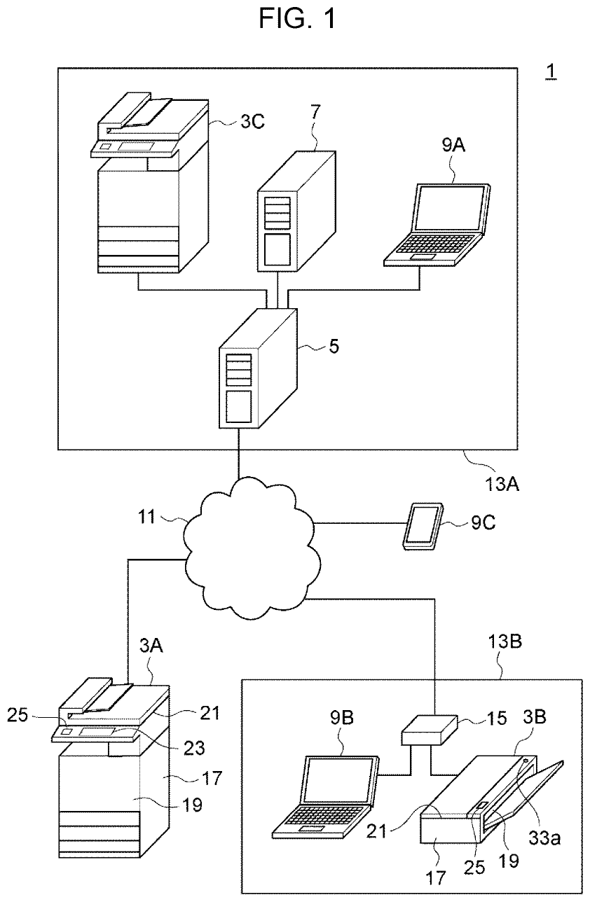

FIG. 1 is a schematic view illustrating a configuration of a communication system 1 according to the embodiment.

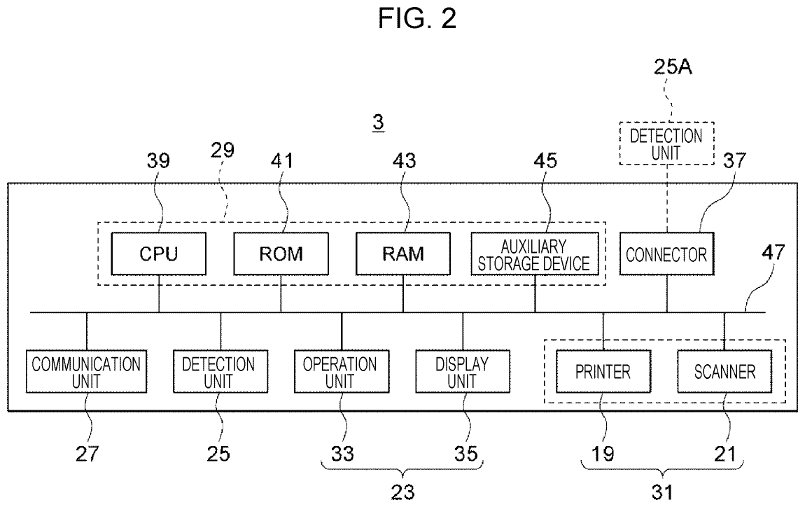

The communication system 1 includes a plurality of communication apparatuses that is communicably connected to one another over a network. The plurality of communication apparatuses includes one or more image processing apparatuses. In the example illustrated in FIG. 1, three image processing apparatuses 3A, 3B, and 3C are illustrated. In the following description, the image processing apparatuses 3A to 3C (and 3D, which will be described later) are sometimes referred to as image processing apparatuses 3 (see FIG. 2 and other drawings for the reference sign) without distinction. Each of the image processing apparatuses 3 includes at least one of a printer or a scanner. The plurality of communication apparatuses includes a server 5 for authenticating a user of the image processing apparatus 3.

For example, when a user attempts to use the image processing apparatus 3, the image processing apparatus 3 detects user's biological information (e.g., a fingerprint) and transmits data for authentication based on the detected biological information to the server 5. The server 5 performs authentication on the basis of the received data for authentication. When the server 5 succeeds in the authentication, the image processing apparatus 3, for example, permits the user to use a predetermined function (e.g., printing). Conversely, when the server 5 fails in the authentication, the image processing apparatus 3 does not permit the user to use the predetermined function.

Such operation may be applied to any of the one or more image processing apparatuses 3 included in the communication system 1. In the following description, any of the image processing apparatuses 3A to 3C is sometimes taken as an example. However, description given for any of the image processing apparatuses 3A to 3C may be applied to other image processing apparatuses unless inconsistency or the like occurs.

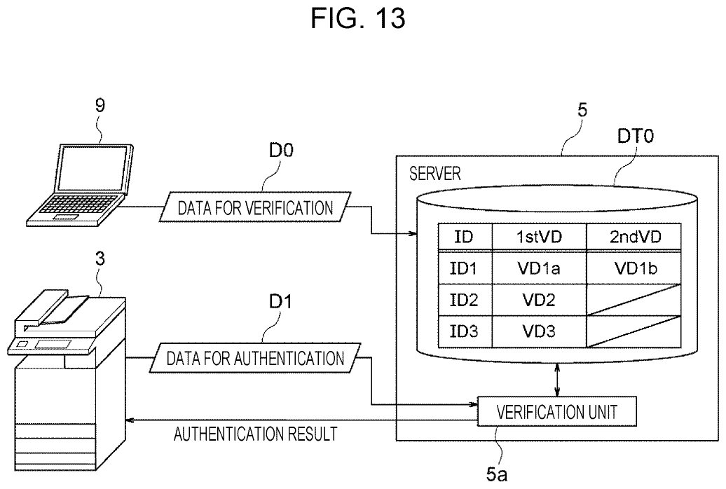

The communication system 1 may include an appropriate communication apparatus in addition to the image processing apparatuses 3 and the server 5. In FIG. 1, a server 7 different from the server 5 and terminals 9A, 9B, and 9C are illustrated. In the following description, the terminals 9A to 9C are sometimes referred to as terminals 9 (see FIG. 13 for the reference sign) without distinction.

An appropriate network may be used to connect the plurality of communication apparatuses. In FIG. 1, a public network 11 and private networks 13A and 13B are illustrated.

Note that the communication system 1 may be defined only by the server 5 and the image processing apparatuses 3 for which authentication is performed by the server 5. The communication system 1 may be defined including other communication apparatuses (the server 7 and the terminals 9) communicable with the server 5 and/or the image processing apparatuses 3 for which authentication is performed by the server 5 in addition to the above. The communication system 1 may be defined including a private network in addition to the above communication apparatuses (5, 3, 7, and 9). In any case, the communication system 1 may be defined excluding the public network 11. The server 5 is a dedicated server in one example, and is a cloud server in another example.

### (Details of Communication System)

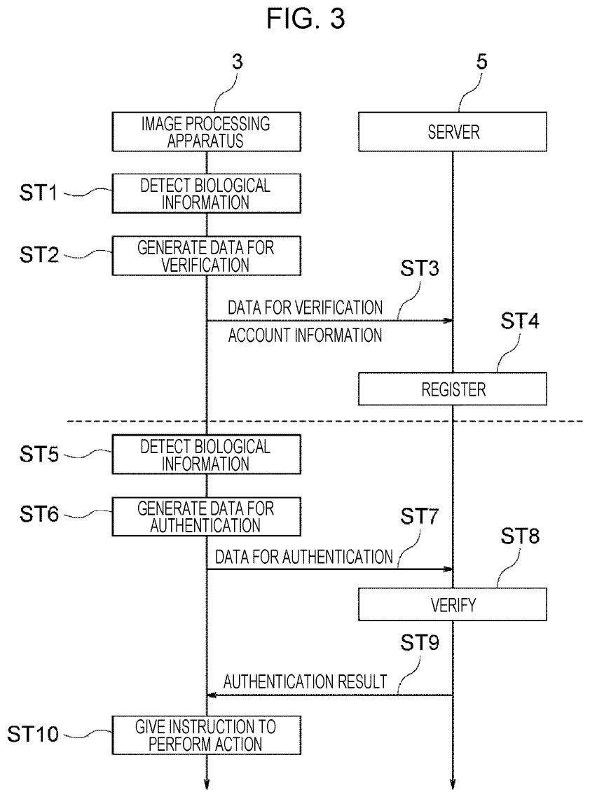

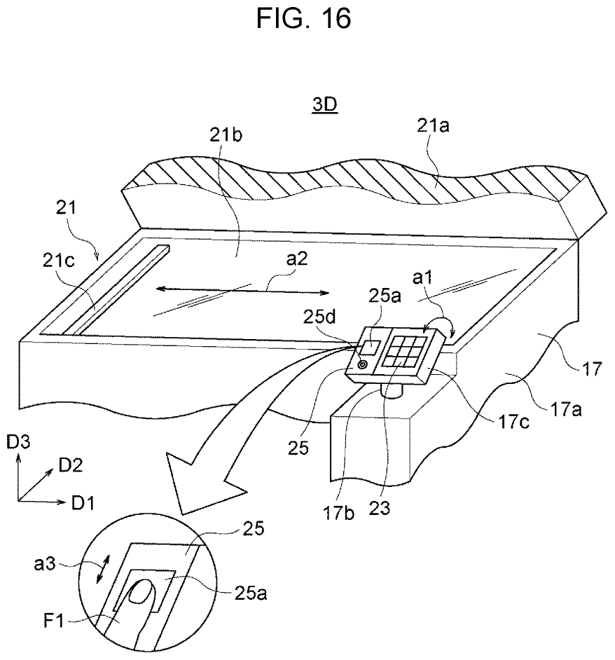

Description will be basically given below in the following order:
Biological information used for authentication by the communication system 1.
An outline of the various communication apparatuses (3, 5, 7, and 9) (FIG. 1).
A manner of connection of the various communication apparatuses. The public network 11 and the private networks 13A and 13B from another perspective (FIG. 1).
A configuration of the image processing apparatus 3 (FIGS. 1 and 2).
Operation of image processing apparatus 3 (FIGS. 3 to 15).
A specific example of configuration and operation of a detection unit 25 (described later) that detects biological information (FIGS. 16 to 19).

### (Biological Information)

As biological information used for authentication by the communication system 1, various kinds of biological information may be used and, for example, information used for known biometric authentication may be used. For example, the biological information may be information on a user's physical feature or may be information on a user's behavioral feature. Specific examples of the physical feature include a fingerprint, a shape of palm, a retina (e.g., a pattern of blood vessels thereof), an iris (e.g., a distribution of density values thereof), a face, a blood vessel (a pattern of a specific portion such as a finger), a shape of an ear, voice (e.g., a voiceprint), and body odor. Examples of the behavioral feature include handwriting.

### (Outline of Communication Apparatuses)

The image processing apparatus 3 includes at least one of a printer or a scanner, as has been already described. The following description mainly takes, as an example, an aspect in which the image processing apparatus 3 includes both a printer and a scanner. The image processing apparatus 3 may be a multi-function product/printer/peripheral (MFP) or may be an apparatus other than the MFP. The image processing apparatus 3 may be able to execute, for example, at least one of printing, scanning, copying, FAX transmission, and FAX reception (note, however, that these are not necessarily separable concepts).

A method of running the image processing apparatus 3 (from another perspective, positioning of the image processing apparatus 3 in the society) can be any method. For example, the image processing apparatus 3A may be installed at a store such as a convenience store and used by a large indefinite number of users. The image processing apparatus 3B may be installed at a company and used by a plurality of specific users. The image processing apparatus 3C may be installed at home and used by a small number of (e.g., one) specific users.

The server 5 may not only authenticate a user who uses the image processing apparatus 3, but also authenticate a user who uses another communication apparatus (e.g., the terminal 9). The server 5 may process service other than authentication. For example, the server 5 may perform enterprise content management (ECM) or may function as a VPN server.

The server 7 may perform various kinds of service. For example, the server 7 may be a file server, a mail server, and/or a web server. When focusing on operation related to the image processing apparatus 3, the file server may store therein, for example, data of an image to be printed by the image processing apparatus 3 or data obtained by scanning by the image processing apparatus 3. The mail server may deliver an e-mail to be printed by the image processing apparatus 3 or an e-mail including an image obtained by scanning by the image processing apparatus 3. The web server may execute a web service through communication with the image processing apparatus 3.

In FIG. 1, the servers 5 and 7 are each expressed as one computer. However, one server may include a plurality of computers that is distributed. The plurality of computers that constitutes the one server may be directly connected, may be included in one LAN, or may be included in different LANs. Note that the servers 5 and 7 may be regarded as one server.

The terminals 9 may be terminals of appropriate kinds. In FIG. 1, the terminals 9A and 9B are illustrated as laptop personal computers (PCs). The terminal 9C is illustrated as a smartphone. Alternatively, the terminals 9 may be, for example, desktop PCs or tablet PCs. A method of running the terminals 9 can be any method. For example, each of the terminals 9 may be one used by one or more specific users such as a terminal owned by a company or a terminal owned by an individual person or may be one used by a large indefinite number of users such as a terminal at an Internet cafe.

### (Manner of Connection of Communication Apparatuses)

The public network 11 is a network opened to an outside (e.g., a large indefinite number of communication apparatuses). A specific aspect of the public network 11 may be an appropriate one. For example, the public network 11 may include the Internet, a closed network offered by a communication service provider, and/or a public telephone network.

The private networks 13A and 13B are networks that are not opened to an outside. The private network 13A and/or 13B may be, for example, a LAN. The LAN may be, for example, a network in the same building. Examples of the LAN include a LAN using Ethernet (Registered Trademark) and a LAN using Wi-Fi (Registered Trademark).

Alternatively, the private network 13A and/or 13B may be an intranet.

Signal transmission and/or reception performed by a communication apparatus (e.g., the image processing apparatus 3) may be performed through wired communication or may be performed through wireless communication. A communication apparatus (e.g., the image processing apparatus 3) may communicate with the public network 11 without being included in a private network or may be included in a private network. A communication apparatus (e.g., the image processing apparatus 3) that is included in a private network may perform only communication within the private network or may communicate with the public network 11 over the private network.

As described above, the plurality of communication apparatuses may be connected to one another in various aspects. In the example of FIG. 1, the plurality of communication apparatuses is connected as follows.

The image processing apparatus 3A does not construct a private network. The image processing apparatus 3A includes a router or the like (not illustrated) or is connected to a router or the like and is thus communicable to the public network 11 without a private network. The image processing apparatus 3A may be communicable with a terminal 9 (not illustrated in FIG. 1) directly connected to the image processing apparatus 3A by wire. The image processing apparatus 3A may be communicable with a terminal 9 (not illustrated in FIG. 1) disposed close to the image processing apparatus 3A through near field wireless communication.

The image processing apparatus 3B and the terminal 9B are connected to each other over the private network 13B. More specifically, the image processing apparatus 3B and the terminal 9B are connected to each other via a router 15 (or a hub thereof). The image processing apparatus 3B and the terminal 9B are communicable with the public network 11 via the router 15 or the like.

The image processing apparatus 3C, the server 5, the server 7, and the terminal 9A are connected to one another over the private network 13A. The image processing apparatus 3C, the server 7, and the terminal 9A are, for example, communicable with the public network 11 via the server 5. The server 5 may include a router or the like or a router or the like (not illustrated) may be provided between the server 5 and the public network 11.

The terminal 9C performs, for example, wireless communication with a public telephone network. Furthermore, the terminal 9C communicates with the public network 11 including a public telephone network.

In the communication system 1, the server 5 performs authentication of a user who uses the image processing apparatus 3, as has been already described. The server 5 performs this authentication, for example, on an image processing apparatus (3A and 3B in FIG. 1) connected to the server 5 over the public network 11. However, the server 5 may perform the authentication not only on the image processing apparatus connected over the public network 11, but also on an image processing apparatus (3C in FIG. 1) included in the private network 13A including the server 5. Alternatively, the server 5 may perform the authentication only on the image processing apparatus included in the private network 13A including the server 5.

A relationship between the manner of connection of the communication apparatuses and the method of running the communication apparatuses (from another perspective, positioning of the communication apparatuses in society) can be any relationship. For example, the image processing apparatus 3A, which is not included in a private network, may be installed at a shop and used by a large indefinite number of users as described above or may be installed at a company and used by a specific user unlike the above description. For example, the image processing apparatus 3B, which is included in the private network 13B, may be installed at home and used by a small number of specific users as described above or may be installed at an Internet cafe and used by a large indefinite number of users unlike the above description.

### (Configuration of Image Processing Apparatus)

FIG. 2 is a schematic view illustrating a hardware configuration related to a signal processing system of the image processing apparatus 3.

As illustrated in FIGS. 1 and 2, the image processing apparatus 3 includes, for example, the following constituent elements: a housing 17 (FIG. 1) that constitutes an outer shape of the image processing apparatus 3, a printer 19 that performs printing, a scanner 21 (image scanner) that performs scanning, an input output unit 23 that receives a user's operation and/or presents information to a user, a detection unit 25 that detects user's biological information, a communication unit 27 (FIG. 2) that performs communication, a control unit 29 (FIG. 2) that controls each unit (19, 21, 23, 25, and 27), and a connector 37 (FIG. 2) for connecting an appropriate device to the image processing apparatus 3. Note that hereinafter, the printer 19 and/or the scanner 21 are sometimes referred to as an image processing unit 31 (see FIG. 2 for the reference sign).

Description regarding the configuration of the image processing apparatus will be basically given below in the following order:
Mutual relationship among the various constituent elements mainly focusing on the housing 17, and others.
Description regarding the various constituent elements other than the housing 17. This description will be basically given in the order in which the various constituent elements are mentioned in the above paragraph.
A manner of connection between the constituent elements other than the housing 17.
   (Mutual Relationship among Constituent Elements of Image Processing Apparatus)

The above constituent elements may be (or may be regarded to be) partially or entirely shared with each other, as in the example illustrated in FIGS. 1 and 2. For example, the housing 17 may be regarded as a part of the printer 19 or the scanner 21. In the description of the present embodiment, the control unit 29 is conceptually one control unit that controls all operations (including, for example, printing and scanning) of the image processing apparatus 3 (may be distributed as a plurality of units in terms of hardware). In this case, the targets (19, 21, 23, 25, and 27) controlled by the control unit 29 may be defined only by a mechanical part that does not include the control unit or may be defined to include the control unit (a part of the control unit 29).

The constituent elements other than the housing 17 (19, 21, 23, 25, 27, and 29; the term “constituent elements” refers to the constituent elements other than the housing 17 in this paragraph and the following three paragraphs) are provided in the housing 17. In other words or from another perspective, it can be said that the housing 17 holds or supports the plurality of constituent elements or is mechanically connected or coupled to the plurality of constituent elements. It can also be said that the plurality of constituent elements is integrally provided by being provided in the housing 17. Note that in such a case where the constituent elements are provided in the housing 17, the housing 17 may be regarded as a part of the constituent elements, as is understood from the above description.

In a case where the constituent elements are provided in the housing 17, the constituent elements and the housing 17 are, for example, typically fixed to each other (excluding a movable part). The constituent elements are also fixed to each other. For example, the constituent elements and the housing 17 cannot be separated from each other and placed at different places unless the image processing apparatus 3 is dismantled, for example, by removing a screw. The constituent elements cannot be separated from each other and placed at different places.

However, in a case where the constituent elements are provided in the housing 17, the constituent elements may be attachable to and detachable from the housing 17, unlike the above example. In FIG. 2, a member attachable to and detachable from the connector 37 is indicated by the dotted line as a detection unit 25A according to a variation.

A specific positional relationship in a case where the constituent elements are provided in the housing 17 can be any positional relationship. For example, the constituent elements may be accommodated in the housing 17, may be provided integrally with a wall surface of the housing 17, may protrude from the wall surface of the housing 17, or may be provided so that directions and/or positions thereof with respect to the housing 17 are variable. In the example of FIGS. 1 and 2, the printer 19, the scanner 21, the communication unit 27, and the control unit 29 may be regarded as being accommodated in the housing 17. The input output unit 23 and the detection unit 25 may be regarded as being provided integrally with the wall surface of the housing 17.

In these cases, the detection unit 25 is preferably provided integrally with the wall surface of the housing 17 rather than protruding from the wall surface of the housing 17.

According to such a configuration, no unnecessary structure is present on the surface of the housing 17, and therefore appearance of the whole image processing apparatus can be improved. Various wires connected to the detection unit 25 are preferably accommodated in the housing 17. According to such a configuration, the various wires connected to the detection unit 25 can be covered with the wall surface of the housing 17, and therefore damage of the various wires can be reduced.

In a case where the image processing apparatus 3 has a movable part (e.g., a lid part of the scanner 21) using an opening closing mechanism or the like, the detection unit 25 is preferably provided not on the movable part but on an immovable part, examples of which include the printer 19 and the input output unit 23. According to the structure in which the detection unit 25 is provided on an immovable part, vibration and the like that occur during opening and closing is less likely to be applied to the detection unit 25, and therefore breakage of the detection unit 25 can be made less likely to occur and decrease in detection accuracy resulting from external force can be kept small, as compared with a structure in which the detection unit is provided on a movable part.

In a case where the detection unit 25 is provided integrally with the wall surface of the housing 17, a detection surface 25a of the detection unit 25 is preferably provided at a substantially identical height (within a range of +8 mm) to the input output unit 23.

The image processing apparatus 3 (from another perspective, the housing 17) can have any size and shape. For example, the image processing apparatus 3 may have a size (mass) that can be carried by one person as in the case of the image processing apparatus 3B such as an MFP or printer for household use or may have a size (mass) that cannot be carried by one person as in the case of the image processing apparatuses 3A and 3C such as an MFP or printer for business use.

### (Printer)

The printer 19 is, for example, configured to perform printing on a sheet placed in the housing 17 or on a tray that protrudes from the housing 17 to an outside and discharge the sheet after the printing. A specific configuration of the printer 19 may be selected from among various configurations and may be, for example, same as and/or similar to a known configuration.

For example, the printer 19 may be an inkjet printer that performs printing by ejecting ink, may be a thermal printer that performs printing by heating thermal paper or an ink ribbon, or may be an electrophotographic printer (e.g., a laser printer) that transfers toner attached to a photoreceptor irradiated with light. The inkjet printer may be a piezoelectric type that gives a pressure to ink by a piezoelectric body or may be a thermal type that gives a pressure to ink by an air bubble generated in ink by application of heat.

For example, the printer 19 may be a line printer whose head has a length covering a width of a sheet (in a direction crossing a sheet transport direction) or may be a serial printer whose head moves in a width direction of a sheet. The printer 19 may be a color printer or may be a black and white printer. The printer 19 may be a printer that can form any image or may be a printer that can print only a character.

### (Scanner)

The scanner 21 performs scanning, for example, by imaging a document placed on document glass by a plurality of imaging elements (not illustrated) that moves along the document glass below the document glass, which is exposed from an upper surface of the housing 17 (hidden by a lid in FIG. 1). A configuration of the scanner 21 may also be selected from among various configurations and may be, for example, same as and/or similar to a known configuration.

### (Input Output Unit)

The input output unit 23 can have any configuration. For example, the input output unit 23 includes an operation unit 33 (see FIG. 2 for the reference sign) that receives a user's operation and a display unit 35 (see FIG. 2 for the reference sign) that visually presents information to the user. Note that the input output unit 23 need not necessarily be provided or only the operation unit 33 or display unit 35 may be provided. The input output unit 23 may further include an acoustic unit that presents information to the user by sound.

The operation unit 33 can have any configuration. The operation unit 33 receives, for example, an operation by user's contact. Such an operation unit 33 may include, for example, a touch panel and/or one or more buttons. In FIG. 1, a touch panel (a reference sign is omitted) is illustrated as at least a part of the operation unit 33 of each of the image processing apparatuses 3A and 3C. A button 33a is illustrated as at least a part of the operation unit 33 of the image processing apparatus 3B. The button 33a may be a push button, may be a touch button, or may be another kind of button. The touch button may be a capacitance type touch button or may be another kind of touch button. Needless to say, the image processing apparatuses 3A and 3C hay have a button, and the image processing apparatus 3B may have a touch panel. Note that the operation unit 33 may receive an operation by a different method such as a voice operation.

### (Display Unit)

The display unit 35 can have any configuration. For example, the display unit 35 may include at least any one of a display that can display any image, a display that can display only any character, a display that can display only a specific character and/or a specific figure, and an indicator light. The “image” as used herein is a concept encompassing a character. The display that displays any image or any character can be, for example, a liquid crystal display or an organic Electro Luminescence (EL) display having a relatively large number of pixels that are regularly arranged. The display that displays a specific character and/or a specific figure can be, for example, a liquid crystal display that has a limited number of pixels and/or a limited shape or a segment display such as a seven-segment display. The segment display may be selected from among various aspects including a liquid crystal display. The indicator light may include, for example, a light emitting diode (LED). The indicator light may be an appropriate number of indicator lights. Note that for convenience of description, the following description sometimes assumes that the display unit 35 can display any image.

Unlike the example illustrated in FIGS. 1 and 2, the image processing apparatus 3 may be conceptually different from a general MFP or printer installed at a company (office) or home. For example, the printer 19 may perform printing on a roll of paper. The image processing apparatus 3 may include a robot and paint a vehicle body or the like by an inkjet head. The image processing apparatus 3 may have a size held in one hand, and the image processing apparatus 3 itself may be scanned with respect to a medium to perform printing and/or scanning.

### (Detection Unit)

As described above, various kinds of biological information can be used for authentication. Accordingly, the detection unit 25 can have various configurations. Even the detection unit 25 that detects the same kind of biological information can have various configurations. A basic configuration of the detection unit 25 may be same as and/or similar to a known configuration.

For example, the detection unit 25 may acquire an image related to biological information. Examples of biological information obtained by acquisition of an image include a fingerprint, a shape of palm, a retina, an iris, a face, a blood vessel, and a shape of an ear. A typical example of the detection unit 25 that acquires an image is an optical detection unit 25. The optical detection unit 25 includes an imaging element that detects light. Light (in other words, a wavelength region) to be detected by the imaging element may be visible light or light (e.g., infrared light) other than visible light. The detection unit 25 may include a lighting unit that irradiates a living body with light of the wavelength region to be detected by the imaging element or may include no lighting unit. The image may be a binary image, a grayscale image, or a color image.

In a case where the detection unit 25 images a blood vessel of a finger (e.g., in a case of finger vein authentication), degradation of the detection unit can be reduced by using a slide type or retractable type as the detection unit 25. The detection unit 25 may automatically shift from a state where the detection unit 25 is accommodated in the housing 17 to a state where the detection unit 25 is exposed to an outside of the housing 17 when biometric authentication is selected or a user is selected by the input output unit 23. That is, the detection unit 25 may be automatically pulled out or flipped up out of the housing 17.

In a case where the detection unit 25 is an optical detection unit, light unnecessary for detection can be reduced by making surroundings of the detection unit 25 dark (3 or less in brightness of the Munsell color system).

The detection unit 25 that acquires an image may be an ultrasonic detection unit. The ultrasonic detection unit 25 includes an ultrasonic element that transmits and receives an ultrasonic wave. As is understood from an ultrasonography for a medical purpose, an image related to a shape of a surface and/or an inside of a living body can be acquired by the detection unit 25 including an ultrasonic element. More specifically, the detection unit 25 transmits an ultrasonic wave to a living body and receives a reflected wave. An image reflecting a distance from the ultrasonic element (i.e., a shape of the living body) is acquired on the basis of a period from the transmission to the reception.

The detection unit 25 that acquires an image may be a capacitance detection unit. The capacitance detection unit 25 includes a panel with which a living body makes contact and a plurality of electrodes arranged along the panel behind the panel. When a part (e.g., a finger) of the living body is placed on the panel, an electric charge occurring at an electrode at a contact position (a position of a raised part of a body surface) and an electric charge occurring at an electrode at a position (a position of a recessed part of the body surface) where the living body is not in contact are different. On the basis of this difference, an image of irregularities (e.g., a fingerprint) of the body surface is acquired.

The detection unit 25 that acquires an image may acquire a two-dimensional image by sequentially performing acquisition of a linear image in a shorter-side direction of the linear image (i.e., performing scanning) or may acquire a two-dimensional image substantially one time without performing such scanning. The scanning may be realized by an action of the detection unit 25 or may be realized by moving a living body relative to the detection unit 25. Examples of the former case include an aspect in which a carriage including an imaging element or an ultrasonic element moves. A plurality of ultrasonic elements may perform electronic scanning without mechanical movement.

One example of the detection unit 25 having a configuration other than the configuration of acquiring an image is a detection unit including a microphone that acquires voice. Thus, information of voice (e.g., a voiceprint) is acquired as biological information.

Another example of the detection unit 25 is a touch panel that receives handwriting using a touch pen. Thus, information of handwriting is acquired as biological information.

The detection unit 25 may be used for a purpose other than acquisition of biological information. From another perspective, the detection unit 25 may be realized by a constituent element provided for a purpose other than acquisition of biological information in the image processing apparatus 3. Alternatively, the detection unit 25 may be structurally integral with another constituent element.

For example, the detection unit 25 that acquires an image may be realized by the scanner 21, unlike the example illustrated in FIGS. 1 and 2. That is, in a case where the image processing apparatus includes a scanner and a detection unit, these members may be an identical constituent element. The same applies to a case where a constituent element that is also used as the detection unit 25 is a constituent element other than the scanner 21.

For example, a button included in the operation unit 33 may also be used as the detection unit 25 to detect a fingerprint when a finger is placed on the button. Such a button and detection unit 25 can be, for example, the capacitance detection unit 25. An operation of the button is detected by a sensor including the plurality of electrodes.

The handwriting may be, for example, received by a touch panel included in the operation unit 33.

### (Communication Unit)

The communication unit 27 is, for example, a part of an interface for communication of the image processing apparatus 3 with an outside (e.g., the public network 11) and is not included in the control unit 29. The communication unit 27 may include only a hardware constituent element or may include a part realized by software in addition to a hardware constituent element. In the latter case, the communication unit 27 need not be clearly distinguishable from the control unit 29.

Specifically, for example, in a case where the image processing apparatus 3 is connected to an outside by wire, the communication unit 27 may have a connector or a port to which a cable is connected. The “port” as used herein is a concept encompassing a software element in addition to a connector. For example, in a case where the image processing apparatus 3 is connected to an outside wirelessly (e.g., by a radio wave), the communication unit 27 may include a radio frequency (RF) circuit that converts a baseband signal into a high-frequency signal and an antenna that converts a high-frequency signal into a radio signal. In both of the case of wired communication and the case of wireless communication, the communication unit 27 may include, for example, an amplifier and/or a filter.

### (Control Unit)

The control unit 29 has, for example, a configuration same as and/or similar to a computer. Specifically, for example, the control unit 29 includes a central processing unit (CPU) 39, a read only memory (ROM) 41, a random access memory (RAM) 43, and an auxiliary storage device 45. The CPU 39 executes a program stored in the ROM 41 and/or the auxiliary storage device 45, and thus the control unit 29 is constructed. Note that the control unit 29 may include a logical circuit configured to perform only certain operation in addition to a portion constructed as described above.

### (Connector)

The connector 37 is, for example, for connecting a peripheral device to the image processing apparatus 3. A standard for the connector 37 may be selected from among various standards, and can be, for example, a USB. In FIG. 2, the detection unit 25A according to the variation is illustrated as a peripheral device connected to the connector 37, as has been already described. Other examples of the peripheral device connected to the connector 37 include a USB memory and a card reader.

### (Manner of Connection of Constituent Elements in Image Processing Apparatus)

The various constituent element (19, 21, 25, 27, 33, 35, 37, 39, 41, 43, and 45) described above are, for example, connected by a bus 47 (FIG. 2). In FIG. 2, schematically, all the constituent elements are connected to one bus 47. In an actual product, a plurality of busses may be connected in an appropriate form. For example, an address bus, a data bus, and control bus may be provided. A crossbar switch and/or link bus may be applied.

FIG. 2 is merely a schematic view. Accordingly, for example, actually, various devices (e.g., a CPU) may be provided in a distributed manner. The CPU 39 illustrated in FIG. 2 may be a concept encompassing a CPU included in the printer 19 or the scanner 21. An interface (not illustrated) may be interposed between the bus 47 and the various devices (e.g., the printer 19 or the scanner 21).

### (Others)

The block diagram of FIG. 2 has been described as a block diagram illustrating the configuration of the image processing apparatus 3. However, the block diagram of FIG. 2 from which the printer 19 and the scanner 21 are omitted can be used as a block diagram illustrating configurations of the servers 5 and 7 and the terminals 9. The description of the constituent elements illustrated in FIG. 2 may also be applied to constituent elements of the servers 5 and 7 and the terminals 9 unless inconsistency or the like occurs. Note that the servers 5 and 7 need not necessarily include the operation unit 33 and/or the display unit 35.

### (Operation of Image Processing Apparatus)

FIG. 3 is a flowchart illustrating an outline of operation of the image processing apparatus 3 and the server 5.

Steps ST1 to ST4 illustrate a procedure in preparation (initial registration) for allowing the server 5 to perform authentication. Steps ST5 to ST10 illustrate a procedure (a procedure during use) in which the image processing apparatus 3 makes a request for authentication to the server 5 from and performs an action according to a result of the authentication. Details are as follows.

Processing in the initial registration including steps ST1 to ST4 is, for example, started by a predetermined operation on the operation unit 33 of the image processing apparatus 3. Note that the operation includes not only an operation of a specific mechanical switch, but also an operation combined with a graphical user interface (GUI). The same applies to operations mentioned in other processing unless otherwise specified and unless inconsistency or the like occurs.

In step ST1, the control unit 29 of the image processing apparatus 3 controls the detection unit 25 to detect user's biological information. In step ST2, the control unit 29 generates data for verification on the basis of the acquired biological information. In step ST3, the control unit 29 causes the communication unit 27 to transmit the data for verification and account information to the server 5.

The data for verification may be the biological information that has not been processed or may be data obtained by processing the biological information, as has been already described. In the former case, step ST2 may be omitted.

The account information includes, for example, information (hereinafter sometimes abbreviated as an “ID”) for identifying a user. The account information may include a password. In the following description, the term “account information” may be interchangeable with the term “ID” (not accompanying a password) or may be interchangeable with the term “ID and password” unless inconsistency or the like occurs.

In step ST4, the server 5 stores therein the received data for verification and account information in association with each other. Alternatively, the server 5 stores therein account information in advance, and stores the received data for verification in association with account information that matches the received account information. In this way, the data for verification is registered.

In actual registration processing, a procedure for reducing probability that a third part irrelevant with the communication system 1 improperly acquires an account and/or a procedure for reducing probability that a third part irrelevant with an existing account improperly associates data for verification with the existing account may be performed. As such procedures, for example, any of various known procedures may be applied.

The processing during use including steps ST5 to ST10 is, for example, started by a predetermined operation on the operation unit 33 of the image processing apparatus 3.

Steps ST5 and ST6 are basically same as and/or similar to steps ST1 and ST2. The data for verification generated in step ST2 and data for authentication generated in step ST6 are, for example, identical except for a difference resulting from an error in detection of biological information. However, in the embodiment, these pieces of data are given different names to distinguish them. Note that for convenience of description, an expression ignoring influence of the error such as “data for authentication and data for verification match” is sometimes used in the following description.

In step ST7, the control unit 29 of the image processing apparatus 3 causes the communication unit 27 to transmit the data for authentication to the server 5. Note that the account information is not transmitted in this step. However, the account information may be transmitted as in step ST3.

In step ST8, the server 5 verifies the received data for authentication by referring to one or more pieces of data for verification registered in advance. For example, the server 5 determines whether or not there is data for verification that matches the received data for authentication. The server 5 determines that authentication has succeeded in a case where there is data for verification that matches the data for authentication. In an aspect in which an ID is also transmitted in step ST7, the server 5 may extract data for verification associated with the received ID, determine whether or not the extracted data for verification and the received data for authentication match, and determine that authentication has succeeded in a case where the extracted data for verification and the received data for authentication match. In step ST9, the server 5 transmits information on an authentication result to the image processing apparatus 3. The authentication result is success of authentication or failure of authentication. However, in the following description, for convenience of description, the term “authentication result” sometimes means success of authentication. The information on the authentication result may be information indicative of the authentication result itself or may be other information (e.g., information on user's authority in the image processing apparatus 3) specified on the basis of the authentication result as will be understood from the later description. Then, the communication unit 27 of the image processing apparatus 3 receives the authentication result of the authentication using the data for authentication (the authentication performed by the server 5).

In step ST10, the control unit 29 of the image processing apparatus 3 gives an instruction to perform an action on the basis of the authentication result. This action is, for example, an action related to the printer 19, the scanner 21, and/or the communication unit 27. The instruction to perform the action is given from the control unit 29 to the printer 19, the scanner 21, and/or the communication unit 27.

Note that the instruction to perform the action may be an instruction given from a higher-level control unit in the control unit 29 to a lower-level control unit in the control unit 29. The lower-level control unit, for example, more directly controls the printer 19, the scanner 21, and/or the communication unit 27 than the higher-level control unit.

The “action” encompasses an action performed in a case of success of authentication and an action performed in a case of failure of authentication. However, in the description of the embodiment, the action performed in a case of success of authentication is mainly described.

In the image processing apparatus 3, only one kind of action may need authentication or two or more kinds of actions may need authentication. One authentication may allow one kind of action to be repeatedly performed or may allow two or more kinds of actions to be performed. However, authentication may be requested for each action, authentication may be requested for each kind of action, or authentication may be requested again when an action of a higher security level is performed.

During use including steps ST5 to ST10, a user may be selected from among a plurality of users displayed on the input output unit 23 (e.g., a touch panel), and then biological information of the user may be detected (step ST5). This can improve convenience in a case where the image processing apparatus 3 is shared among a limited number of users (e.g., in an office).

Thereafter, the authentication is canceled (not illustrated). The cancellation is triggered by an appropriate event. The cancellation of authentication can be, for example, rephrased as returning to a state where a user has not been authenticated. The cancellation of authentication may involve end of an action (e.g., VPN connection, which will be described later) based on the authentication and/or disabling (e.g., deletion from a storage unit) of information (e.g., authority information, which will be described later) acquired based on the authentication. Conversely, it may be regarded that the authentication has been canceled when the action is ended and/or the information is disabled.

The biological information used for the authentication may be deleted from the image processing apparatus 3 immediately after generation of the data for authentication. The data for authentication may be deleted from the image processing apparatus 3 immediately after transmission to the server 5. However, the biological information and/or the data for authentication may be stored in the image processing apparatus 3 and used as appropriate until a later appropriate timing (e.g., a timing of cancellation of authentication). The same applies to the data for verification.

As described above, the image processing apparatus 3 according to the embodiment includes the image processing unit 31, the detection unit 25, the communication unit 27, and the control unit 29. The image processing unit 31 includes at least one of the printer 19 or the scanner 21. The detection unit 25 detects user's biological information (step ST5). The communication unit 27 transmits data for authentication based on the biological information detected by the detection unit 25 to an external authentication apparatus (the server 5) (step ST7). The communication unit 27 transmits the data for authentication based on the biological information detected by the detection unit 25 and receives an authentication result of authentication using the data for authentication (authentication performed by the server 5). The control unit 29 gives an instruction to perform an action related to the image processing unit 31 and the communication unit 27 on the basis of the authentication result (step ST10).

The communication system 1 according to the embodiment includes the image processing apparatus 3 and the external authentication apparatus (the server 5). The image processing apparatus 3 includes the image processing unit 31, the detection unit 25, the communication unit 27, and the control unit 29. The image processing unit 31 includes at least one of the printer 19 or the scanner 21. The detection unit 25 detects user's biological information. The communication unit 27 transmits data for authentication based on the biological information detected by the detection unit 25. The control unit 29 gives an instruction to perform an action related to the image processing unit 31 and the communication unit 27. The external authentication apparatus (the server 5) receives the data for authentication from the image processing apparatus 3 and performs authentication. Then, the control unit 29 gives an instruction to perform an action (an action related to the image processing unit 31 and the communication unit 27) based on an authentication result of the external authentication apparatus (the server 5).

Accordingly, for example, the image processing apparatus 3 need not have a function of verifying biological information detected from a user (step ST8). From another perspective, the image processing apparatus 3 need not store therein the data for verification (step ST2) for a long term for comparison with the data for authentication. As a result, for example, in a case where the image processing apparatus 3 is used by a large indefinite number of users, probability that the data for verification (in other words, biological information) is improperly acquired from the image processing apparatus 3 is reduced. That is, improvement of secrecy of biological information is expected. For example, a user does not need to register data for verification in advance in each of the image processing apparatuses 3 which the user plans to use. In other words, the user can use any image processing apparatus 3 included in the communication system 1 at any time. That is, convenience improves. For example, since biological information is detected by the detection unit 25 of the image processing apparatus 3, the image processing apparatus 3 need not perform operation of acquiring biological information by performing near field wireless communication with a user's terminal disposed close to the image processing apparatus 3. As a result, for example, probability that biological information leaks during communication for acquiring biological information from the terminal is reduced.

### (Details of Operation of Image Processing Apparatus)

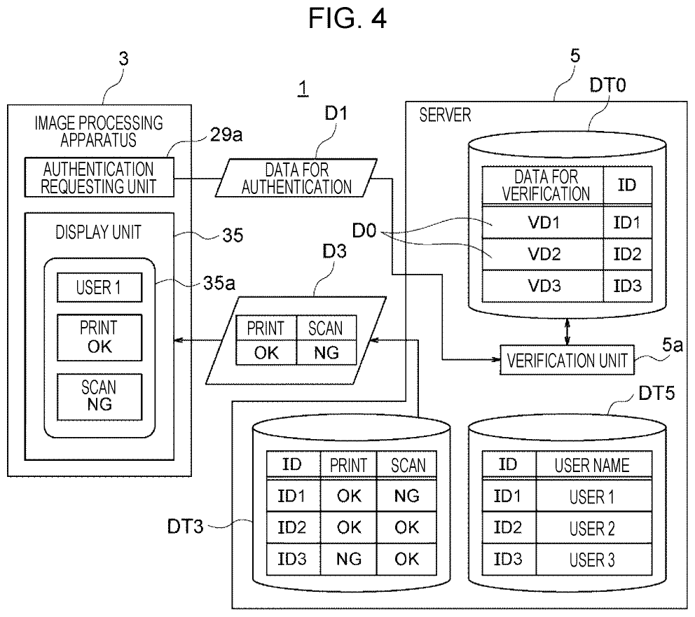

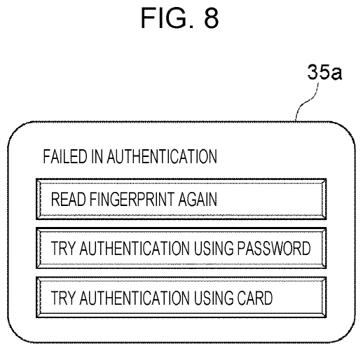

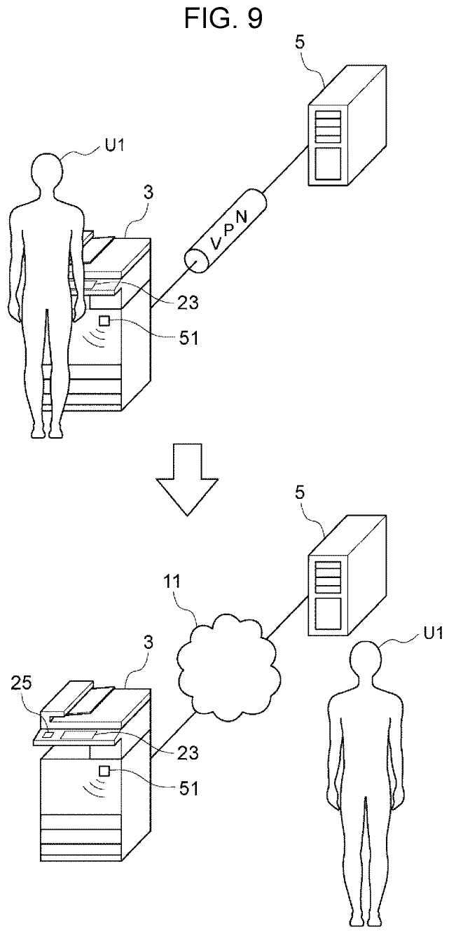

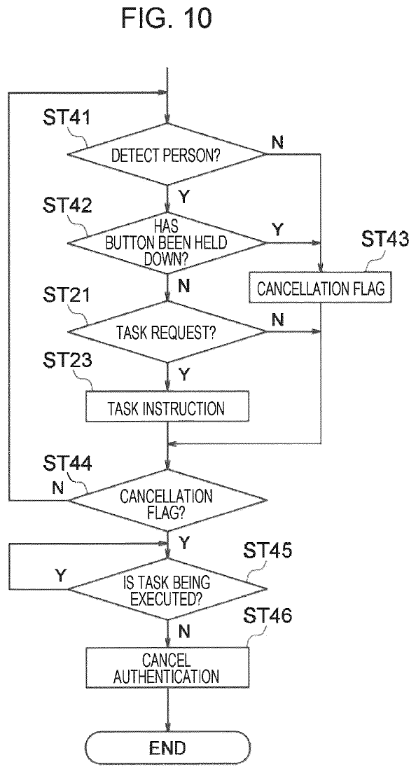

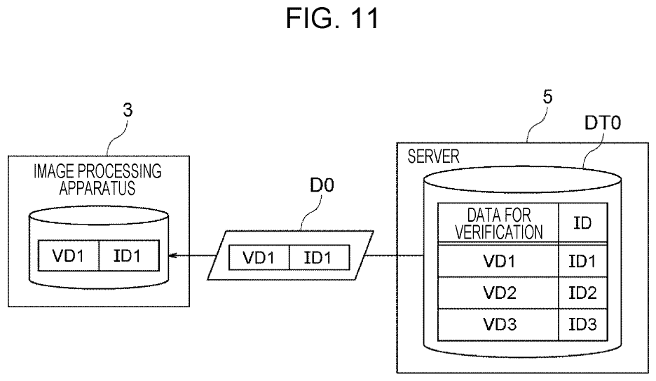

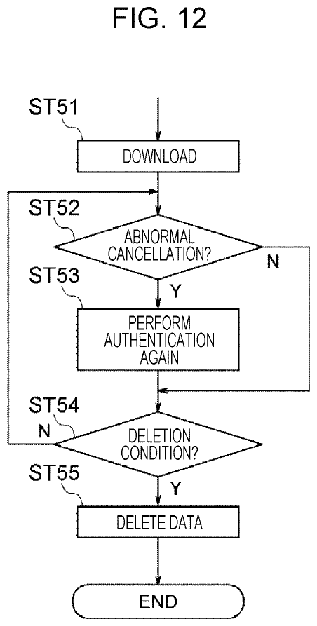

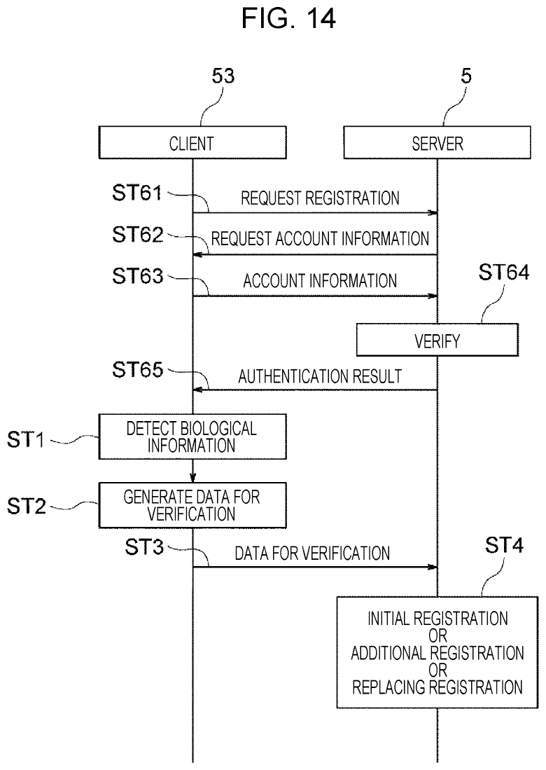

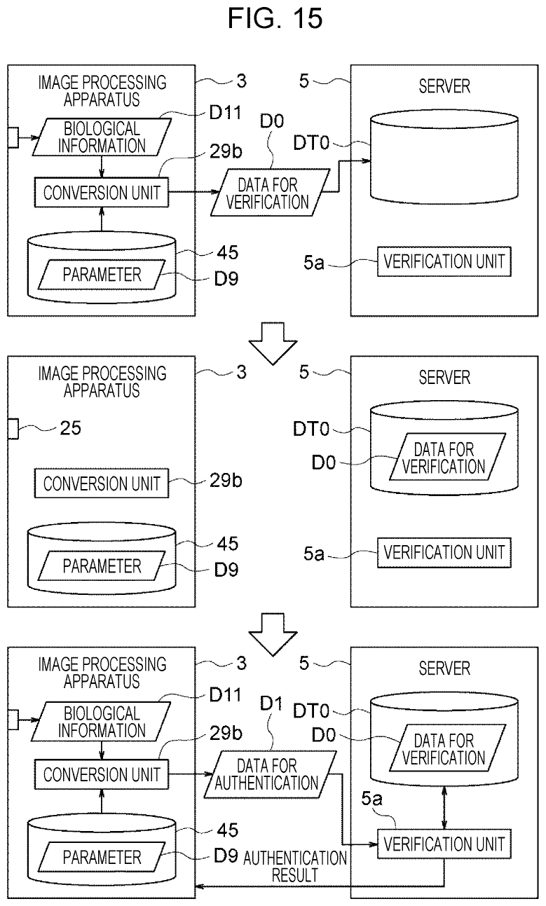

The above operation of the image processing apparatus 3 (the communication system 1) may be performed in more specific various aspects. The following describes the specific aspects of the operation of the image processing apparatus 3 in the following order:
Three examples of the action in step ST10 (FIGS. 4 to 7).
An example of operation in a case where authentication fails in step ST8 (FIG. 8).
An example of operation related to cancellation of authentication (FIGS. 9 and 10).
An example of operation in a case where authentication is canceled due to an abnormality (FIGS. 11 and 12).
A specific example or variation of registration of data for verification (FIGS. 13 and 14).
An example of a method for generating data for authentication in step ST6 (FIG. 15).

### First Example of Action: Cancellation of Function Restriction

The action performed in response to the instruction given on the basis of the authentication result may be, for example, cancellation of restriction of a function related to the printer 19 and/or the scanner 21. For example, in a case where a user has not been authenticated on the basis of biological information in the image processing apparatus 3, the user is prohibited from downloading data from an external data processing apparatus (e.g., another image processing apparatus 3, the server 5 or 7, or the terminal 9) and printing the data. That is, even when a print job is transmitted from the terminal 9 to the image processing apparatus 3 or the user performs an operation for printing on the operation unit 33 of the image processing apparatus 3, printing is not performed by the image processing apparatus 3. When the user is authenticated on the basis of biological information, such printing is enabled.

The image processing apparatus 3 has various functions. All of the various functions excluding a function for authentication may be restricted or one or some of the various functions may be restricted. From another perspective, a user who has failed in authentication may be substantially prohibited from using the image processing apparatus 3 or may be permitted to use one or some functions. As an example of the latter case, even a user who has failed in authentication may be permitted to print (copy) an image of a document read by the scanner 21 by the printer 19. For example, only a user who has succeeded in authentication may be permitted to perform printing using the printer 19 based on data from an outside (e.g., the server 7, the terminal 9, or another image processing apparatus 3) and/or transmission of data of an image read by the scanner 21 to an outside.

A manner in which function restriction is canceled in a case where authentication has succeeded may be common to all users or may be set individually for each user. From another perspective, in the former case, there are only two kinds of users, that is, a user who has not been authenticated and for whom function restriction has not been canceled and a user who has been authenticated and for whom function restriction has been canceled. There may be no difference in available functions among users for whom function restriction has been canceled. An example of the latter case is described. Assume that a user who has not been authenticated cannot use both a first function and a second function. In this case, as users who have been authenticated, there may be two or more kinds of users selected from among a user who can use only the first function, a user who can use only the second function, a user who can use both the first function and the second function, and a user who has been authenticated but is restricted to use the functions similarly to a user who has not been authenticated.

Examples of the restricted function are as follows. One or more of the plurality of functions below are selected as appropriate as a restricted function. Note that the plurality of functions below may include overlapping functions or inseparable functions.

A first example of the restricted function is printing using the printer 19. The printing to be restricted may be divided into smaller functions. For example, the printing may be divided into printing based on data received by the communication unit 27, printing based on data stored in a device (e.g., a non-volatile memory) connected to the connector 37, and printing based on scanning using the scanner 21. Restriction of the printing based on data received by the communication unit 27 may be further divided in accordance with a communication apparatus that transmitted the data (e.g., another image processing apparatus 3, the server 5 or 7, or the terminal 9). Note that such restriction of printing may be substantially realized by restriction of a communication partner. Restriction of the printing based on data received by the communication unit 27 may be further divided in accordance with a manner of communication (typical data communication, e-mail reception, or FAX reception). Restriction of the printing based on data stored in the memory connected to the connector 37 may be further divided in accordance with what kind device is connected or which device is connected. Note that such restriction of printing may be substantially realized by restriction of a device connectable to the connector 37 (device control).

Another example of the restricted function is scanning using the scanner 21. As in the case of printing, scanning to be restricted may be divided into smaller functions. For example, the scanning may be divided into scanning for copying (printing), scanning for transmission of data (e.g., image data), and scanning for data storage. The scanning for transmission of data may be further divided in accordance with a communication apparatus to which the data is to be transmitted (e.g., another image processing apparatus 3, the server 5 or 7, or the terminal 9). Note that such restriction of scanning may be substantially realized by restriction of a transmission destination. The scanning for transmission of data may be further divided in accordance with a manner of communication (typical data communication, e-mail reception, or FAX reception). The scanning for data storage may be further divided in accordance with a memory in which the data is to be stored (e.g., the RAM 43, the auxiliary storage device 45, or the device connected to the connector 37). The scanning for storage in the device connected to the connector 37 may be further divided in accordance with what kind device is connected or which device is connected. Note that such restriction of scanning may be substantially realized by restriction of a device connectable to the connector 37.

The restricted function need not be a main function such as printing or scanning. For example, the restricted function may be a function for setting concerning a main function, such as a function of setting a margin size of paper on which printing is to be performed. However, such a function may be regarded as a function of performing printing after freely setting a margin and may be regarded as one kind of main function.

The restricted function may be a function used by an administrator of the image processing apparatus 3. For example, the image processing apparatus 3 may be able to receive setting of prohibiting one or some of the above main functions or prohibiting connection of a predetermined device to the image processing apparatus 3 uniformly (irrespective of a result of user authentication). Such restriction of the setting may be canceled for a specific user (the administrator of the image processing apparatus 3).

Note that cancellation of function restriction has been described as an example of the action in step ST10 of FIG. 3. However, processing (sometimes referred to as a task) related to the various functions performed after cancellation of restriction of the functions may also be regarded as an example of the action performed upon receipt of the instruction given on the basis of the authentication result.

### Specific Example Concerning Cancellation of Function Restriction

The above operation of restriction cancellation may be realized in more specific various aspects. The following illustrates an example.

FIG. 4 is a block diagram illustrating an example of a configuration of a signal processing system of the communication system 1 that realizes the above operation.

An authentication requesting unit 29a included in the control unit 29 of the image processing apparatus 3 transmits data for authentication D1 to the server 5 (corresponding to step ST7). The server 5 has a verification table DT0 in which one or more pieces of data for verification and one or more IDs are associated. A verification unit 5a included in the control unit of the server 5 searches for data for verification D0 that matches the received data for authentication D1 by referring to the verification table DT0 (corresponding to step ST8). In a case where there is data for verification D0 that matches the received data for authentication D1, the verification unit 5a specifies an ID associated with the data for verification D0. Then, the server 5 extracts authority information D3 associated with the specified ID by referring to an authority table DT3 in which an ID and the authority information D3 are associated. Then, the server 5 transmits the extracted authority information D3 to the image processing apparatus 3. The control unit 29 of the image processing apparatus 3 cancels function restriction on the basis of the received authority information D3.

Note that the authority information D3 is transmitted on the premise that there is data for verification D0 that matches the received data for authentication D1 (authentication has succeeded), the transmission of the authority information D3 may be regarded as transmission of information on a verification result. In a case where there is no data for verification D0 that matches the received data for authentication D1, the server 5 may transmit information on failure of authentication to the image processing apparatus 3. The authority information may be, for example, stored in the authority table DT3 in association with an ID by an administrator of the server 5 before the above operation (in other words, step ST5 to ST10 of FIG. 3) is performed.

The above configuration and operation are merely an example and are conceptual configuration and operation for easy description. The configuration and operation for canceling restriction of authority may be changed and/or concretized as appropriate.

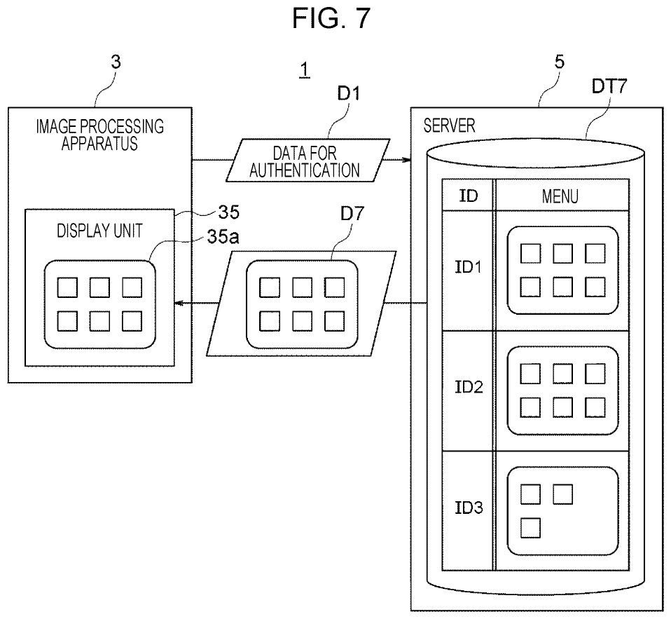

For example, the verification table DT0 and the authority table DT3 may be unified, and the data for verification and the authority information may be directly associated without an ID. The same applies to other tables having information associated with an ID (e.g., a user information table DT5, which will be described later, and a menu table DT7, which will be described later with reference to FIG. 7). Conversely, the illustrated tables may be divided as appropriate. For example, in the authority table DT3 illustrated in FIG. 4, an ID and information on restriction of each function are directly associated. Unlike the example illustrated in FIG. 4, a table in which an ID and any of a predetermined number of authority levels are associated and a table in which each of the predetermined number of authority levels and information on restriction of each authority are associated may be stored in the server 5.

For example, a part of the operation of the server 5 may be performed by the control unit 29 of the image processing apparatus 3.

More specifically, for example, the image processing apparatus 3 may have the authority table DT3. When notified of success of authentication by the server 5, the control unit 29 may extract authority information D3 associated with an ID input by a user or an ID transmitted from the server 5 by referring to the authority table DT3 which the image processing apparatus 3 has and cancel function restriction.

For example, in a case where the authority table DT3 is divided into a table in which an ID and an authority level are associated and a table in which an authority level and information on restriction of each function are associated, the image processing apparatus 3 may have both of the two tables or may have only the latter table. In a case where the image processing apparatus 3 has only the table in which an authority level and information on restriction of each function are associated, the server 5 transmits information on an authority level to the image processing apparatus 3 as the authority information D3 unlike the example illustrated in FIG. 4. Then, the control unit 29 may extract information on restriction of each function associated with the received authority level by referring to the table which the image processing apparatus 3 has and cancel function restriction.

The control unit 29 of the image processing apparatus 3 that has received or extracted authority information may display information on authority on the display unit 35. In FIG. 4, the authority information is displayed on a screen 35a of the display unit 35. In this case, the control unit 29 may display user information on the screen 35a together with the authority information. The user information includes, for example, a user name. The user information may include other information such as a group to which the user belongs.

Specifically, in the example illustrated in FIG. 4, the server 5 has the user information table DT5 in which an ID and a user name are associated. The user name may be, for example, stored (registered) in the user information table DT5 in association with an ID by a user and/or the administrator of the server 5 before the operation illustrated in FIG. 4 (in other words, steps ST5 to ST10 of FIG. 3) is performed. As in the case of extraction of authority information from the authority table DT3 and transmission of the authority information, the server 5 extracts a user name corresponding to the ID specified by the verification unit 5a from the user information table DT5 and transmits the user name to the image processing apparatus 3. The control unit 29 of the image processing apparatus 3 displays the received user name on the screen 35a.

Note that the image processing apparatus 3 may have the user information table DT5, unlike the above case. When notified of success of authentication by the server 5, the control unit 29 may extract user information associated with an ID input by the user or an ID transmitted from the server 5 by referring to the user information table DT5 which the image processing apparatus 3 has and display the user information on the display unit 35. As has been already mentioned, the user information table DT5 may be united with the verification table DT0 and/or the authority table DT3, and the user information may be directly associated with data for verification and/or authority information without an ID. Although a user name is defined separately from an ID in the example illustrated in FIG. 4, an ID may be used as a user name and displayed on the screen 35a.

In a case where a user name is registered by a user, authentication may be performed as appropriate so that a user name is not improperly registered by a third party. This authentication may be performed by biometric authentication described above or may be performed by another method. Note that description of registration of data for verification, which will be described later with reference to FIG. 14, may be applied to registration of a user name. The same applies to other information (e.g., menu information D7, which will be described later with reference to FIG. 7).

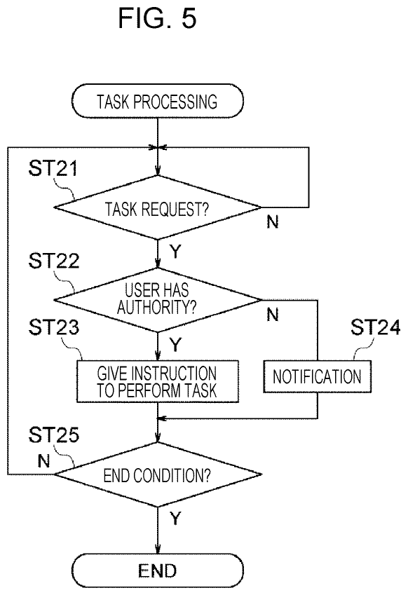

FIG. 5 illustrates an example of a procedure of processing performed by the control unit 29 of the image processing apparatus 3 to restrict a function and cancel the restriction.

The processing of FIG. 5 may be started as appropriate. First, an aspect in which the processing is started when the image processing apparatus 3 is shifted to an activation mode, for example, by an operation of a power switch of the image processing apparatus 3 is described as an example. In this case, the authentication (steps ST5 to ST10) and the processing for specifying (receiving or extracting) authority information described with reference to FIGS. 3 and 4 may be performed in parallel with the processing of FIG. 5 at an appropriate timing during execution of the processing of FIG. 5.

In step ST21, the control unit 29 determines whether or not execution of a task such as printing has been requested by an operation of the operation unit 33, communication using the communication unit 27, or the like. Then, the control unit 29 waits (in another perspective, repeats step ST21 on a predetermined cycle) in a case where a result of the determination is negative. In a case where the result of the determination is positive, the control unit 29 proceeds to step ST22. Note that for convenience of description, the task is limited to a task for which execution is restricted and the restriction is canceled.

In step ST22, the control unit 29 determines whether or not the user has authority to execute the requested task. In a case where a result of the determination is positive, the control unit 29 proceeds to step ST23, and in a case where the result of the determination is negative, the control unit 29 proceeds to step ST24.

Note that in a case where authority information has not been specified at a time of step ST22 and in a case where authentication has been canceled and the authority information has been disabled, it may be determined that the user has no authority. Examples of the case where the authority information has not been specified include a case where the authentication processing has not been performed and a case where the authentication has failed.

In step ST23, the control unit 29 controls the printer 19 and/or the scanner 21 to perform the requested task (e.g., printing).

In step ST24, the control unit 29 notifies the user of restriction of execution (function) of the requested task. For example, this notification may be visually given or may be acoustically given. The visual notification may be given by displaying a predetermined image and/or character, may be given by shifting a predetermined indicator light into a predetermined state (an on state, a blinking state, or an off state), or may be given by a combination thereof. The acoustic notification may be given by outputting predetermined voice and/or warning sound (buzzer sound or melody). The same may apply to notification in other steps.

In step ST25, the control unit 29 determines whether or not a predetermined end condition has been satisfied. In a case where a result of the determination is negative, the control unit 29 returns to step ST21, and in a case where the result of the determination is positive, the control unit 29 ends the processing illustrated in FIG. 5. The end condition may be, for example, same as and/or similar to a condition of end of activation of the image processing apparatus 3 or a condition of shift to a standby mode.

The above processing may be changed as appropriate.

For example, in the above description, the task is limited to a task for which execution is restricted and the restriction is canceled, for convenience of description.

However, the control unit 29 may determine between steps ST21 and ST22 whether or not the requested task is a task for which execution is restricted and the restriction is canceled, and in a case where a result of the determination is positive, the control unit 29 may proceed to step ST22, whereas in a case where the result of the determination is negative, the control unit 29 may proceed to step ST23.

For example, the control unit 29 may determine between steps ST21 and step ST22 whether or not authority information that is effective (authentication has not been canceled) at the time has been specified, and in a case where a result of the determination is positive, the control unit 29 may proceed to step ST22, whereas in a case where the result of the determination is negative, the control unit 29 may give a notification. In this notification, the control unit 29 may display information requesting authentication (input of biological information) from the user on the display unit 35. Then, the control unit 29 may proceed to step ST25 or may wait until biological information becomes detectable (e.g., until a finger is placed on the detection unit 25 that detects a fingerprint). In the latter case, when the biological information becomes detectable, the control unit 29 may perform the authentication (step ST5 to ST10) and the processing of specifying authority information, which have been described with reference to FIGS. 3 and 4, and proceed to step ST22. However, in a case where the biological information does not become detectable even after elapse of a predetermined period or in a case where a predetermined canceling operation is made, the control unit 29 may proceed to step ST25.

For example, the processing of FIG. 5 may be started when a condition that the authentication (step ST5 to ST10) and the processing of specifying authority information, which have been described with reference to FIGS. 3 and 4, have been performed is satisfied. In this case, the end condition of step ST25 may be a condition that the authentication has been canceled and the authority information has been disabled. In this case, for example, in a case where authentication has not been performed, information (e.g., an image) requesting input of biometric authentication from the user may be displayed on the display unit 35.

Note that the operation of specifying authority information of a user who has been authenticated described with reference to FIG. 4 is, from another perspective, operation of storing received or extracted authority information so that the authority information can be referred to in step ST22. In a case where the stored authority information includes information indicating that the user has authority concerning at least one function, this operation may be regarded as an example of the operation of giving an instruction to cancel restriction of the function on the basis of the authentication result. The positive determination in step ST22 and the instruction to perform a task in step ST23 may also be regarded as an example of the operation of giving an instruction to cancel restriction of the function on the basis of the authentication result.

As described above, in the first example of the action, the control unit 29 gives an instruction to cancel restriction of a function related to the image processing unit 31 on the basis of a result of authentication performed by the external authentication apparatus (the server 5).

As has been already described, biometric authentication (more specifically, verification of data for authentication based on biological information) is performed in the server 5. Accordingly, for example, function restriction for users who have not been registered for biometric authentication is collectively managed through management of the verification table DT0 in the server 5. From another perspective, since the biological information is managed in the server 5 to increase secrecy of the biological information, convenience of authority management improves. In a case where the server 5 has the authority table DT3, authority can be managed in a unified manner, and therefore convenience of authority management further improves.

In the first example, the image processing apparatus 3 may display user information and authority information on the display unit 35 on the basis of the authentication result.

In this case, the user can easily grasp his or her authority. As a result, for example, probability of occurrence of a situation where the user instructs the image processing apparatus 3 to perform an action such as printing although the user has no authority and then notices that the user has no authority is reduced. That is, user's convenience improves.

### Second Example of Action: VPN Connection

The action performed upon receipt of the instruction given on the basis of the authentication result may be, for example, operation of enabling at least one of transmission or reception of image data between the image processing unit 31 and an external data processing apparatus (e.g., another image processing apparatus 3, the server 5 or 7, or the terminal 9) through VPN connection established on the basis of the authentication result.

The VPN, for example, virtually expands a private network to the public network 11. From another perspective, the VPN logically divides physically one network including the public network 11. Thus, for example, communication using the public network 11 is performed under a secure environment.

Such virtual expansion or logical division is, for example, realized by authentication, tunneling, and encryption. However, the communication using the VPN may be realized by authentication and tunneling without performing encryption. Note that the tunneling can also be regarded as one kind of encryption.

In the authentication, authenticity as a target for which connection is established is checked. Examples of a method of the authentication include a method using account information (an ID and a password), a method using a static key, a method using a common key (shared key), a method using a combination of a private key and a public key, a method using an electronic signature, a method using an electronic certificate, a method using a security token, and a method using a combination (e.g., multi-factor authentication) of two or more of these methods.

However, in the second example of the action, at least the authentication based on biological information (the authentication described with reference to steps ST5 to ST8 of FIG. 3) is performed as the authentication for VPN connection.

In the tunneling, operation for handling physically or logically separate two points as an identical point over a network is performed. The tunneling is, for example, realized by encapsulation. In the encapsulation, for example, a whole packet is embedded in a payload of another protocol, a payload of another layer, or a payload of an identical layer in communication. The tunneling may be performed in an appropriate layer. For example, the tunneling may be performed in a layer 3 (network layer) or a layer 2 (data link layer). In the encryption, information to be transmitted or received is converted into information in a format that cannot be decrypted by a third party. The encryption may be performed only on a payload or may be performed on both of a header and a payload. From another perspective, the encryption may be performed in an appropriate layer. For example, the encryption may be performed in a network layer, a transport layer, and/or a session layer. An appropriate method may be used for the encryption. Examples of the method of the encryption include a method using a common key and a method using a combination of a private key and a public key.

The VPN may be of an appropriate kind. For example, remote access VPN and/or a LAN (site-to-site) VPN may be applied as the VPN of the communication system 1. In the remote access VPN, for example, VPN client software is installed into a communication apparatus such as the image processing apparatus 3, and the communication apparatus directly performs VPN connection with the server 5 serving as a VPN server. In the LAN VPN, for example, a VPN gateway VPN-connects LANs (locations).

However, as the second example of the action, operation of the image processing apparatus 3 functioning as a client of the remote access VPN is taken as an example. In the example of FIG. 1, the image processing apparatus 3A or 3C may be regarded as the image processing apparatus 3 that performs the second example of the action.

As has been already described, the public network 11 can have various aspects. From a perspective of the kind of VPN, the following aspects may be employed. The VPN may be an Internet VPN, in which the Internet is included in the public network 11. The VPN may be an IP (Internet Protocol)-VPN, an entry VPN, or a wide-area ethernet, in which a closed network provided by a communication provider or the like is included in the public network 11.

A protocol for the VPN may be a known protocol, may be a new protocol, or may be a protocol defined by the administrator of the server 5. Examples of a known protocol for the remote access VPN include a combination of Layer 2 Tunneling Protocol (L2TP) and Security Architecture for Internet Protocol (IPsec), and a Point to Point Tunneling Protocol (PPTP).

### Specific Example Concerning VPN Connection

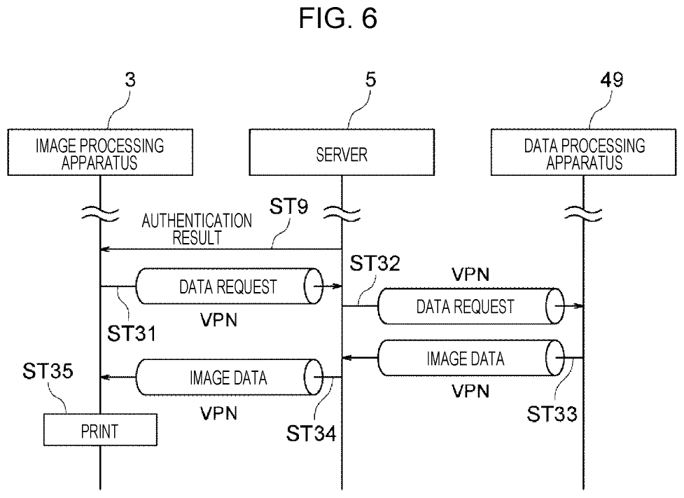

FIG. 6 is a flowchart for explaining a specific example of the above operation.

In FIG. 6, the image processing apparatus 3 is an image processing apparatus (3A or 3B) that communicates, as a client of the remote access VPN, with the server 5 serving as a VPN server, as has been already described. A data processing apparatus 49 is an apparatus that communicates with the image processing apparatus 3 over the VPN (from another perspective, the server 5 serving as a VPN server). The data processing apparatus 49 can be, for example, another image processing apparatus 3, the server 7, or the terminal 9. Although the data processing apparatus 49 may be the server 5, an aspect in which the data processing apparatus 49 and the server 5 are different is taken as an example in FIG. 6. The data processing apparatus 49 that is not the server 5 may be an apparatus (3C, 7, or 9A) that is included in the private network 13A including the server 5 or may be an apparatus (3A, 3B, or 9B) that is not included in the private network 13A. In FIG. 6, the latter apparatus is taken as an example.

The processing illustrated in FIG. 6 is, for example, started when a start condition of VPN connection is satisfied in the image processing apparatus 3. The start condition may be, for example, satisfied when a predetermined operation for giving an instruction to perform VPN connection is made on the operation unit 33. The start condition may be satisfied when a task that requires VPN connection (e.g., operation of downloading image data from the data processing apparatus 49 and printing the image data) is performed on the operation unit 33. When an instruction to perform such a task is given, a user may be given an inquiry about whether or not to perform VPN connection, and the start condition may be satisfied when a predetermined operation for giving an instruction to perform VPN connection is performed.

The start condition may be satisfied when a predetermined signal is input from an external communication apparatus (e.g., the terminal 9).

When the start condition of VPN connection is satisfied, steps ST5 to ST9 of FIG. 3 are performed. That is, processing for authentication is performed. In FIG. 6, only step ST9 is illustrated. When the authentication succeeds, VPN connection is performed.

A specific procedure performed after the start condition of VPN connection (described above) is satisfied until steps ST5 to ST9 of FIG. 3 are performed may be an appropriate one.

For example, when the start condition is satisfied, the control unit 29 of the image processing apparatus 3 transmits a signal requesting VPN connection to the server 5. The server 5 that has received the signal transmits a signal requesting transmission of data for authentication to the image processing apparatus 3. The control unit 29 that has received the signal displays information (e.g., an image) requesting the user to perform detection of biological information on the display unit 35. Then, steps ST5 to ST9 are performed.

Alternatively, when the start condition is satisfied, the control unit 29 displays information requesting the user to perform detection of biological information on the display unit 35. Next, the control unit 29 performs step ST5 (detection of biological information) and ST6 (generation of data for authentication). Next, data requesting VPN connection and data for authentication are transmitted. Note that these pieces of data may be separately transmitted or may be transmitted together. Then, step ST8 and ST9 are performed.

Unlike the above description, VPN connection may be automatically performed when the authentication in steps ST5 to ST9 succeeds instead of performing the determination of the start condition before the authentication. In other words, the start condition of VPN connection may be success of authentication. In this case, a timing, a condition, and the like of authentication may be set as appropriate.

When the authentication succeeds and VPN connection is established, the image processing apparatus 3 performs communication using the VPN. In FIG. 6, operation of downloading image data from the data processing apparatus 49 and printing the image data is illustrated. Specifically, the following operation is performed.

In step ST31, the image processing apparatus 3 transmits a signal requesting download of image data to the server 5 over the VPN. Note that the image data may be typical image data or may be image data as a print job.

In step ST32, the server 5 transmits (transfers) the signal requesting the image data to a transmission destination (in this example, the data processing apparatus 49) specified by information included in the received signal. In a case where the data processing apparatus 49 is a communication apparatus outside the private network 13A including the server 5, the transmission may be performed over the VPN (the example illustrated in FIG. 6). In a case where the data processing apparatus 49 is a communication apparatus included in the private network 13A, ordinary communication within the private network 13A may be performed. Note that the former case is based on the premise that the data processing apparatus 49 establishes VPN connection with the server 5 before step ST32.

In step ST33, the data processing apparatus 49 transmits the requested image data to the server 5. As in step ST32, the VPN may be used in a case where the data processing apparatus 49 is located outside the private network 13A (the example illustrated in FIG. 6), whereas ordinary communication within the private network 13A may be performed in a case where the data processing apparatus 49 is located inside the private network 13A.

In step ST34, the server 5 transmits (transfers) the received image data to the image processing apparatus 3. This transmission is performed over the VPN.

In step ST35, the image processing apparatus 3 performs printing based on the received image data.

The user using the image processing apparatus 3 may be allowed to select the VPN server with which the image processing apparatus 3 performs VPN connection or may be prohibited from selecting the VPN server. In the former case, the image processing apparatus 3 may select a connection partner only from among two or more VPN servers that constitute one VPN or may select a connection partner from among two or more VPN servers that constitute two or more different VPNs.

In a case where a VPN server to which the image processing apparatus 3 is to be connected is selectable, the control unit 29 of the image processing apparatus 3 may, for example, display information (e.g., an image) inquiring of the user the server 5 to which the image processing apparatus 3 is to be connected on the display unit 35. This information may be, for example, one presenting information on one or more candidates for the connection partner or may be one prompting input of information on the connection partner. The information on the connection partner that is presented and/or input is, for example, a host name or an IP address (or a name given to the VPN). The information on the connection partner may be any name and/or figure stored in advance in the auxiliary storage device 45 in association with a host name or a fixed IP address by the administrator of the image processing apparatus 3. The control unit 29 may receive an operation on the operation unit 33 such as an operation of selecting a connection partner from among the plurality of candidates or an operation of inputting information on the connection partner by key input or the like. When the VPN connection is established, the control unit 29 may display information indicative of the connection partner with which the VPN connection has been established on the display unit 35.

The VPN connection may be cut off when an appropriate cut-off condition is satisfied. For example, the cut-off condition may be satisfied when a predetermined operation for giving an instruction to cut off the VPN connection is performed on the operation unit 33.

In the aspect in which the VPN connection is established on the basis of an instruction to perform a task that requires VPN connection, the cut-off condition may be satisfied when the task is finished. For example, the cut-off condition may be satisfied when the authentication is canceled. Note that an example of a condition on which the authentication is canceled will be described later.

During the VPN connection, the control unit 29 may cause information indicating that the VPN connection is being established to be displayed on the display unit 35. For example, an image indicating that the VPN connection is being established may be displayed or a specific indicator light may shift into a specific state (e.g., an on state or a blinking state). Although the above description mentioned that the connection partner of the VPN may be displayed, displaying the connection partner may be regarded as an example of the information indicating that the VPN connection is being established.

In the above description, the operation in which the image processing apparatus 3 receives image data from the data processing apparatus 49 and performs printing has been taken as an example. However, other various kinds of operation can be performed as operation using the VPN. For example, information (e.g., image data) acquired by the scanner 21 may be transmitted to the data processing apparatus 49 over the VPN.

Note that the authentication in steps ST5 to ST9 is included in operation for establishing VPN connection. This operation for establishing the VPN connection may be regarded as an example of operation that enables at least one of transmission or reception of image data between the image processing unit 31 and the data processing apparatus 49 through VPN connection.

As described above, in the second example of the action, the control unit 29 enables at least one of transmission or reception of image data (steps ST31 to ST34) between the image processing unit 31 and an external data processing apparatus (the data processing apparatus 49) through VPN connection established on the basis of an authentication result of the external authentication apparatus (the server 5) (steps ST5 to ST9).

As has been already described, biometric authentication (more specifically, verification of data for authentication based on biological information) is performed in the server 5. One comparative example is an aspect in which biometric authentication is performed in an image processing apparatus, and when the authentication succeeds, VPN connection is permitted unconditionally or by authentication in a VPN server using a password. In such an aspect, there is a possibility that VPN connection is improperly established by some sort of improper act on the biometric authentication function in the image processing apparatus. On the other hand, in the present embodiment, probability of occurrence of such an improper act is reduced. That is, VPN security improves.

### Third Example of Action: Menu Screen

The action performed in response to receipt of the instruction given on the basis of the authentication result may be, for example, operation of setting a menu screen of the display unit 35 for each user.

The menu screen is, for example, a screen (image) of a GUI including one or more options. When an option is selected by a pointing device, processing corresponding to the option is performed. For example, in an aspect in which the operation unit 33 and the display unit 35 are a touch panel, corresponding processing is performed when any of one or more options displayed on the display unit 35 is pressed by a finger or a touch pen.

The processing corresponding to the option displayed on the menu screen of the image processing apparatus 3 may be any of various kinds of processing. For example, the option may be processing for performing operation related to a main function such as printing, scanning, copying, FAX transmission, or FAX reception (however, these functions are not necessarily separable concepts). In addition/alternatively, the option may be processing for making settings concerning the above operation. Examples of such settings include selection of a size of paper, settings of a printing magnification, and a printing density. Note that although the description of the first example of the action (cancellation of function restriction) mentioned that the main functions may be divided as appropriate and authority may be set for each divided function, this description of the division may be applied to division of the option as appropriate.

The menu screen for each user may reflect user's preference and/or may reflect user's authority, for example. One example of the former menu screen is such a menu screen that a position, a size, a color, a shape, and the like of a specific option within the screen 35a are set to suit user's preference. One example of the latter menu screen is such a menu screen that a display form of an option related to a predetermined function varies depending on whether or not the user has authority for the predetermined function. More specific examples of the latter menu screen are such a screen that a color of an option varies depending on whether or not the user has authority and such a screen that only an option for which the user has authority is displayed (an option for which the user has no authority is not displayed).

Note that in the aspect in which only an option for which the user has authority is displayed on the menu screen, the user can give only an instruction to perform processing corresponding to the option for which the user has authority. Therefore, this aspect can be regarded as an example of the first example of the action (cancellation of function restriction).

Setting of the menu screen for each user based on an authentication result may be, for example, setting of only two kinds of menu screens, that is, a menu screen for a user who has succeeded in authentication and a menu screen for other users. Alternatively, for example, different menu screens may be set for different users who have succeeded in authentication. No menu screen may be displayed for a user who does not succeed in authentication.

The image processing apparatus 3 may be able to display a main menu screen that is displayed first and one or more sub menu screens displayed by selection of an option displayed on the main menu screen. In this case, the menu screen set for each user may be the main menu screen, may be at least one of the one or more sub menu screens, or may be both of these two kinds of menu screens. By setting the menu screen for each user, whether or not to display the sub menu screens may be set and/or the number of sub menu screens that can be displayed among a plurality of sub menu screens may be set.

### Specific Example Concerning Setting of Menu Screen

The setting of the menu screen may be realized in more specific various aspects. The following illustrates an example.

FIG. 7 is a block diagram illustrating a configuration of a signal processing system of the communication system 1 that realizes the above setting.

As in FIG. 4, the image processing apparatus 3 includes the authentication requesting unit 29a, and the server 5 includes the verification table DT0 and the verification unit 5a although illustration of these members is omitted. In this example, the server 5 has the menu table DT7 in which an ID and menu information D7 for specifying a form of a menu screen (in other words, settings of a menu screen) are stored in association.

As in FIG. 4, the authentication requesting unit 29a of the image processing apparatus 3 transmits data for authentication D1 (step ST7 of FIG. 3). The verification unit 5a of the server 5 searches for data for verification D0 that matches the received data for authentication D1 by referring to the verification table DT0 (step ST8 of FIG. 3). In a case where there is data for verification D0 that matches the received data for authentication D1, the verification unit 5a specifies an ID associated with this data for verification D0. Then, the server 5 extracts menu information D7 associated with the specified ID by referring to the menu table DT7. Then, the server 5 transmits the extracted menu information D7 to the image processing apparatus 3. The control unit 29 of the image processing apparatus 3 displays a menu screen based on the received menu information D7 on the screen 35a of the display unit 35.

The menu information D7 may be set by a user and/or the administrator of the server 5. For example, in a case where user's preference is reflected in at least a part of settings of the menu screen for each user, the part may be set by the user. In a case where whether or not a user has authority is reflected in at least a part of settings of the menu screen for each user, the part may be set by the administrator of the server 5. Note that in a case where the menu information D7 is set by a user, authentication of the user may be required to prevent a third party from improperly setting the menu information D7.

The above configuration and operation are merely an example and are conceptual configuration and operation for easy description. The configuration and operation for setting of the menu screen may be changed and/or concretized as appropriate.

For example, the menu table DT7 may be unified with at least one of the other tables (DT0, DT3, and DT5), as mentioned in the description of the authority table DT3. Conversely, the menu table DT7 may be divided as appropriate. For example, an aspect in which an ID and information set for each of a plurality of setting items concerning the menu screen are directly associated in the menu table DT7 is conceptually illustrated in FIG. 7. Unlike the example illustrated in FIG. 7, tables obtained by dividing the menu table DT7 may be used. For example, a table in which an ID and any of a predetermined number of kinds of menu screens are associated and a table in which each of the predetermined number of kinds of menu screens and information set for each of a plurality of setting items concerning the menu screen are associated may be stored in the server 5.

For example, the image processing apparatus 3 may have the menu table DT7. When notified of success of authentication by the server 5, the control unit 29 may extract menu information D7 associated with an ID input by a user or an ID transmitted from the server 5 by referring to the menu table DT7 which the image processing apparatus 3 has and display the extracted menu information D7 on the display unit 35.

For example, in a case where the menu table DT7 is divided into a table in which an ID and a kind of menu screen are associated and a table in which a kind of menu screen and information of each setting item concerning the menu screen are associated, the image processing apparatus 3 may have both of these two tables or may have only the latter table. In a case where the image processing apparatus 3 has only the table in which a kind of menu screen and information of each setting item are associated, the server 5 transmits, as menu information D7, information on the kind of menu screen to the image processing apparatus 3, unlike the example illustrated in FIG. 7. Then, the control unit 29 may extract information for each setting item associated with the received menu information D7 by referring to the table which the image processing apparatus 3 has and display a menu screen on the basis of the extracted information.

For example, in a case where settings of the menu screen for each user reflect only user's authority (does not reflect user's preference), the menu screen for each user may be set on the basis of the authority information D3 transmitted from the server 5 to the image processing apparatus 3 without transmitting the menu information D7 from the server 5 to the image processing apparatus 3. In this case, the image processing apparatus 3 may have, for example, a table in which the authority information D3 and the menu information D7 are associated and set a menu screen on the basis of the authority information D3 by referring to this table.

Note that the aspect in which only an option for which the user has authority is displayed on the menu screen may be regarded as an example of the first example of the action (cancellation of function restriction), as has been already described. In this case, for example, the authority information described with reference to FIG. 4 need not necessarily be used and the processing described with reference to FIG. 5 need not necessarily be performed. However, the menu information D7 can be regarded as one kind of authority information.

As described above, in the third example of the action, the menu screen of the display unit 35 is set for each user on the basis of the authentication result.

As has been already described, biometric authentication (more specifically, verification of data for authentication based on biological information) is performed in the server 5. Accordingly, for example, users to which different menu screens are provided can be sorted through management of the verification table DT0 in the server 5. From another perspective, since biological information is managed in the server 5 to increase secrecy of the biological information, convenience concerning setting of a menu screen improves. Since the server 5 has the menu table DT7, settings of the menu screen can be managed in a unified manner, and therefore convenience further improves.

### Example of Operation performed in Case of Failure of Authentication

The image processing apparatus 3 and others may perform appropriate operation in a case where authentication fails in steps ST5 to ST9 of FIG. 3. The following describes an example.

The control unit 29 of the image processing apparatus 3 may display predetermined information on the display unit 35 and/or output predetermined sound from a speaker (not illustrated) when the control unit 29 determines that authentication has failed. The display may be realized in an appropriate aspect. For example, the display may be realized by a predetermined image (which may include a character) displayed on a display such as a liquid crystal display, may be realized by a character displayed on a display such as a segment display, or may be realized by turning on or blinking an LED on a rear side of a panel having a light-shielding region or a light-transmitting region that forms a predetermined character string or figure. The sound may be, for example, voice and/or warning sound (buzzer sound or melody).

FIG. 8 is a schematic view illustrating an example of an image displayed on the screen 35a of the display unit 35 when authentication fails.

In this example, an aspect in which the display unit 35 is a touch panel is assumed. Options available to a user are displayed on the screen 35a. Contents of the options are the following three: “READ FINGERPRINT AGAIN”, “TRY AUTHENTICATION USING PASSWORD”, and “TRY AUTHENTICATION USING CARD”. The character strings that express the contents of the options are displayed on buttons on a GUI.

Note that an aspect in which a fingerprint is used as biological information is assumed here, as is understood from the above options. However, the biological information may be biological information other than a fingerprint. Therefore, for example, the term “READ FINGERPRINT AGAIN” may be interchangeable with a term indicating inputting other biological information again as appropriate.

When the user selects “READ FINGERPRINT AGAIN”, the control unit 29, for example, displays an image prompting the user to place a finger on the detection unit 25 on the screen 35a and proceeds to step ST5 of FIG. 3. When the user selects “TRY AUTHENTICATION USING PASSWORD”, the control unit 29, for example, displays, on the screen 35a, an image prompting the user to perform an operation of inputting a password by using a keyboard. Then, the control unit 29 performs processing for performing authentication using a password instead of the biometric authentication (steps ST5 to ST9 of FIG. 3). When the user selects “TRY AUTHENTICATION USING CARD”, the control unit 29, for example, displays, on the screen 35a, an image prompting the user to perform an operation of reading an authentication card by a card reader (not illustrated) of the image processing apparatus 3. Then, the control unit 29 perform processing for performing authentication using an authentication card instead of the biometric authentication (steps ST5 to ST9 of FIG. 3).

Note that in the above description, when the user selects “READ FINGERPRINT AGAIN”, an image prompting the user to place a finger on the detection unit 25 is displayed on the screen 35a. In this case, displaying the option “READ FINGERPRINT AGAIN” can be regarded as displaying information prompting the user to read a fingerprint again, and information displayed subsequently prompting the user to place a finger on the detection unit can also be regarded as displaying information prompting the user to read a fingerprint again. The same applies to the other options.

As is understood from the above example, information of which the user is notified when authentication fails may be, for example, information prompting the user to retry biometric authentication and/or information inquiring whether to switch to authentication other than the biometric authentication. Note that the authentication other than the biometric authentication is, in other words, authentication different from authentication using data for authentication.

As the authentication different from the authentication using data for authentication, only one kind of authentication may be presented or two or more kinds of authentication may be presented (the example illustrated in FIG. 8). The different authentication is not limited to the authentication using a password (in other words, key input) and the authentication using an authentication card and may be any of other kinds of authentication. For example, the different authentication may be connecting a USB memory in which information necessary for authentication is recorded. Alternatively, the different authentication may be biometric authentication using biological information different from a fingerprint.

An option of giving up authentication may be displayed (not illustrated). In the example illustrated in FIG. 8, options for respective kinds of authentication are illustrated as options of performing authentication different from the authentication using a fingerprint.

However, options for respective kinds of authentication may be displayed after different authentication is selected.

Failure of authentication can occur in any stages of steps ST5 to ST9 of FIG. 3. The control unit 29 of the image processing apparatus 3 may determine that authentication has failed as appropriate. For example, in step ST5, in a case where biological information cannot be detected or in a case where detection fails (e.g., in a case where a feature amount is a value outside an assumed range), the control unit 29 can determine that authentication has failed. For example, in a case where information on an authentication result (step ST9) cannot be received from the server 5 or in a case where received information on an authentication result indicates failure of authentication, the control unit 29 can determine that authentication has failed.

As described above, in a case where authentication using data for authentication fails, the image processing apparatus 3 may display, on the display unit 35, at least one of information prompting the user to perform detection using the detection unit 25 again or information inquiring whether to switch to authentication different from authentication using data for authentication.

Here, the biological information can vary with passage of time or depending on a user's physical condition. As a result, even a result of authentication of a legitimate user sometimes becomes an error. In such a case, in a case where the user is prompted to perform detection again and/or is given an inquiry as to whether or not to perform different authentication, the user can easily shift to a next action. That is, user's convenience improves. Since the different authentication is available, it is possible to avoid a situation where processing that requires authentication cannot be performed if authentication does not succeed even in a case where detection of biological information is performed again. In addition/alternatively, when the user is in a hurry, the user can perform processing that requires authentication while skipping the trouble of registering biological information again. Also from such a perspective, user's convenience improves.

### (Cancellation of Authentication)

Cancellation of authentication can be rephrased as returning to a state where a user has not been authenticated, as has been already described. Cancellation of authentication may be, for example, grasped by end of operation that requires authentication and/or disabling of information whose acquisition requires authentication. For example, in an aspect in which a flag indicative of success of authentication is set upon success of the authentication, cancellation of authentication may be grasped by operation of putting the flag down. This case need not necessarily involve end of operation that requires authentication and/or disabling of information whose acquisition requires authentication.

Cancellation of authentication may be triggered by various events. Examples of such events include the following: A user's predetermined operation on the operation unit 33. In a case where the image processing apparatus 3 requests a user to perform detection of biological information when the user tries to use a function that requires authentication (e.g., a function of downloading predetermined image data and printing the predetermined image data), end of a task related to the function. Elapse of a predetermined period from a predetermined time (e.g., a time of a last operation on the operation unit 33).

Cancellation of authentication may require detection of biological information by the detection unit 25 (needless to say, need not necessarily require detection of biological information by the detection unit 25). For example, information (e.g., an image) prompting input of biological information may be displayed on the display unit 35 upon occurrence of an event that triggers cancellation of authentication exemplified above, and biological information may be thus detected. Alternatively, detecting again biological information of a user who has already succeeded in authentication may trigger cancellation of authentication.

In a case where biological information is needed for cancellation of authentication, for example, probability of occurrence of unintended cancellation of authentication is reduced. More specifically, for example, probability of occurrence of cancellation resulting from an erroneous operation of the operation unit 33 is reduced. The image processing apparatus 3 sometimes perform operation for a relatively long term. Examples of such operation include a large volume of scanning, a large volume of printing, transmission of a large volume of data, and reception of a large volume of data. Probability that authentication is canceled by a third party or the like when the user leaves the image processing apparatus 3 during execution of such operation is reduced.

Biological information newly detected for cancellation of authentication may be used for cancellation of authentication by an appropriate method. For example, the newly detected biological information may be used in a manner same as and/or similar to the authentication (steps ST5 to ST9 of FIG. 3), and the authentication may be cancelled when a positive result is obtained from the server 5. For example, the newly detected biological information and biological information detected earlier for the authentication may be compared, and the authentication may be cancelled when these pieces of biological information match. For example, data for authentication based on the newly detected biological information and data for authentication generated earlier for the authentication may be compared, and the authentication may be cancelled when these pieces of data for authentication match.

As is understood from the above description, when an event that triggers cancellation of authentication occurs, the authentication may be cancelled upon occurrence of the event or may be cancelled when a predetermined condition (detection of biological information in the above case) is satisfied later. Examples of the predetermined condition include not only detection of biological information, but also end of a task that is being performed. This reduces probability that cancellation of authentication causes unintended inconvenience for the task that is being performed.

The task may be any of various tasks. For example, the task may be operation of the image processing unit 31. Specifically, for example, the task is printing using the printer 19, scanning using the scanner 21, or a combination thereof (copying, which is printing of a scanned image). The task (operation of the image processing unit 31 or the like) may be, for example, a task whose execution requires authentication or may be a task whose execution does not require authentication.

FIG. 9 is a schematic view illustrating an example different from the above examples regarding an event that triggers cancellation of authentication.

In the upper stage of FIG. 9, a user U1 is located around the image processing apparatus 3. At this time, authentication has not been canceled. Here, an aspect in which cancellation of the authentication involves cutoff of VPN connection is assumed. The state where the authentication has not been cancelled is expressed by illustration indicating that VPN connection is enabled between the image processing apparatus 3 and the server 5.

On the other hand, in the lower stage of FIG. 9, the user U1 is away from the image processing apparatus 3. Since the user U1 is away from the image processing apparatus 3, the authentication has been cancelled. Moreover, the VPN connection has been cut off, and the image processing apparatus 3 is simply connected to the public network 11.

Whether or not the user U1 is away from the image processing apparatus 3 may be determined as appropriate. In the example of FIG. 9, the image processing apparatus 3 has a human sensor 51, and a state where the user U1 is away from the image processing apparatus 3 is detected on the basis of a detection result of the human sensor 51. The human sensor 51 can have various configurations.

A target to be directly detected by the human sensor 51 may be any of various targets, and may be, for example, an infrared ray, an ultrasonic wave, and/or visible light. The human sensor 51 that detects an infrared ray detects, for example, an infrared ray (from another perspective, heat) emitted from a person or the like. The human sensor 51 that detects an ultrasonic wave, for example, transmits an ultrasonic wave in a predetermined direction or range and detects a reflected wave. The human sensor 51 that detects visible light detects visible light reflected by a person or the like or visible light that is not blocked by a person or the like.

The human sensor 51 may detect a person (need not necessarily be able to distinguish a person and another object: the same applies hereinafter) within a predetermined distance from the human sensor 51 on a straight line extending from the human sensor 51 or may detect a person in a region expanding in a conical shape from the human sensor 51. The human sensor 51 may detect presence of a person itself and/or may detect movement of a person. The human sensor 51 may detect a person on the basis of a difference between a physical amount (e.g., an amount of heat) of a person and a physical amount of surroundings or may detect a person without using such a difference.

A range where a person is detected by the human sensor 51 may be set as appropriate in the image processing apparatus 3. As has been already described, this range may be, for example, a linear range or may be, for example, a conical range. A size of the range may be set as appropriate. In the example illustrated in FIG. 9, the detection range is set on a side where the input output unit 23 (the operation unit 33 and/or the display unit 35) and/or the detection unit 25 are located relative to the image processing apparatus 3 in plan view.

Note that it can be determined that the user U1 is away from the image processing apparatus 3 by a method other than the human sensor 51. For example, as has been already described, the trigger that cancels authentication may be elapse of a predetermined period from a last operation on the operation unit 33. This may be regarded as one kind of a determination result indicating that the user U1 is away from the image processing apparatus 3.

FIG. 10 is a flowchart illustrating an example of a procedure of processing performed by the control unit 29 of the image processing apparatus 3 to realize the above operation of canceling authentication. This processing is, for example, started when authentication succeeds in steps ST5 to ST9 of FIG. 3.

In step ST41, the control unit 29 determine whether or not a person has been detected by the human sensor 51. In a case where a result of the determination is positive, the control unit 29 proceeds to step ST42, and in a case where the result of the determination is negative, the control unit 29 proceeds to step ST43.

In step ST42, the control unit 29 determines whether or not a predetermined reset button has been held down. This operation is an example of an operation for giving an instruction to cancel authentication. The reset button may be the independent button 33a (see FIG. 1) or may be a button (not illustrated) on a touch panel. In a case where a result of the determination is negative, the control unit 29 proceeds to step ST21, and in a case where the result of the determination is positive, the control unit 29 proceeds to step ST43.

In step ST43, the control unit 29 sets a cancellation flag. That is, when an event that triggers cancellation of authentication occurs (when a negative result is obtained in step ST41 or a positive result is obtained in step ST42), a cancellation flag is set. Then, the control unit 29 proceeds to step ST44 while skipping steps ST21 and ST23.

Steps ST21 and ST23 are same as and/or similar to steps ST21 and ST23 of FIG. 5. That is, the control unit 29 determines whether or not execution of a task such as printing has been requested (step ST21). In a case where a result of the determination is positive, the control unit 29 gives an instruction to execute the requested task (step ST23). However, description of processing such as determining whether or not the user has authority is omitted. Processing performed in a case where a result of the determination in step ST21 is negative is added to FIG. 5. In a case where the result of the determination in step ST21 is negative, the control unit 29 proceeds to step ST44.

In step ST44, the control unit 29 determines whether or not a cancellation flag has been set. In a case where a result of the determination is negative, the control unit 29 returns to step ST41, and in a case where the result of the determination is positive, the control unit 29 proceeds to step ST45.

In step ST45, the control unit 29 determines whether or not the task is being executed. In a case where a result of the determination is positive, the control unit 29 waits (repeats step ST45), and in a case where the result of the determination is negative, the control unit 29 proceeds to step ST46.

In step ST46, the control unit 29 cancels the authentication.

As described above, the image processing apparatus 3 may further include the human sensor 51. In a case where the human sensor 51 detects that the user U1 has moved away (the result of the determination in step ST41 is negative), the image processing apparatus 3 may cancel authentication of the user U1 (step ST46) after end of operation of the image processing unit 31 (in a case where the result of the determination in step ST45 is negative).

In this case, for example, since cancellation of authentication is triggered when the user U1 moves away from the image processing apparatus 3, probability that a third party uses the image processing apparatus 3 as the user U1 is reduced. As a result, for example, probability that a third party uses a function which the third party is not authorized to use and probability that a third party uses VPN connection which the third party is not permitted to use are reduced. For example, probability that a third party improperly acquires, from the image processing apparatus 3, information used for authentication (biological information and/or data for authentication) and/or information whose acquisition requires authentication (e.g., authority information) is reduced by deleting these pieces of information in addition to cancellation of authentication. On the other hand, since authentication is cancelled after end of operation of the image processing unit 31, printing and/or scanning is continued even if the user U1 moves away from the image processing apparatus 3, for example, when the printing and/or scanning take a long time. This improves user's convenience.

The image processing apparatus 3 may further include a reset button (e.g., the button 33a in FIG. 1). The image processing apparatus 3 may cancel user's authentication when the button 33a is held down (including a case where a touch button is tapped and held by a finger). Note that in such a case, the authentication may be canceled after the end of operation of the image processing unit 31, as in the case of cancellation using the human sensor 51. That is, holding down the button 33a may be one of the one or more triggers.

In this case, cancellation of authentication can be received with a simple configuration. On the other hand, probability that authentication is canceled when the button 33a is unintentionally touched is reduced. Since holding down is required, the button 33a for another purpose can be used as the reset button. As a result, the operation unit 33 can be reduced in size.

### Example of Operation in Case Where Authentication is Canceled Due to Abnormality

After success of authentication, the authentication is sometimes canceled due to an abnormality. For example, connection (e.g., VPN connection) established on the basis of authentication is sometimes cut off due to some sort of communication failure, and as a result, the server 5 (and the image processing apparatus 3) sometimes cancels the authentication. In this case, the image processing apparatus 3 can perform various kinds of operation.

For example, the image processing apparatus 3 displays information (e.g., an image) indicating that the authentication has been canceled on the display unit 35. The image processing apparatus 3 displays, on the display unit 35, information requesting input of biological information or information inquiring whether or not to perform biometric authentication again. Then, steps ST5 to ST9 of FIG. 3 may be performed.

For example, the image processing apparatus 3 may hold the data for authentication D1 (FIG. 4) generated in step ST6 until authentication is canceled by a normal procedure, and may start processing for re-authentication from step ST7. In this case, the re-authentication may be automatically performed without displaying information indicating that the authentication has been cancelled and/or information inquiring whether or not to perform biometric authentication again. However, such information may be displayed. Note that examples of the normal cancellation of authentication include not only cancellation based on an operation of the operation unit 33 or the like, but also cancellation based on a detection result of the human sensor 51.

FIG. 11 is a schematic view illustrating still another example of the operation.

When the image processing apparatus 3 transmits the data for authentication D1 (step ST7) and succeeds in initial authentication (step ST8), data for verification D0 determined to match the data for authentication D1 and account information (an ID in the example illustrated in FIG. 11) may be downloadable from the verification table DT0 of the server 5. Note that the download may be transmission of information on an authentication result in step ST9 or may be performed thereafter.

The image processing apparatus 3 holds the data for verification D0 and account information thus downloaded in the RAM 43 or the auxiliary storage device 45 until a predetermined condition is satisfied. In a case where authentication is canceled due to an abnormality, the held data for verification D0 is transmitted instead of the data for authentication D1 (corresponding to step ST7 of FIG. 3), and re-authentication is performed. In this case, the re-authentication may be performed automatically without displaying information indicating that the authentication has been canceled and/or information inquiring whether or not to perform biometric authentication again. Note, however, that such information may be displayed.

In the authentication, whether or not the data for verification D0 matches data for verification D0 is determined. Therefore, for example, a stricter degree of matching may be required in the determination to increase security as compared with a case where the data for authentication D1 and the data for verification D0 are compared or a load of the matching determination processing can be lessened.

When the data for verification D0 is transmitted from the image processing apparatus 3 to the server 5, the account information may be transmitted together. In this case, the server 5 need just specify an ID that matches the received ID and determine whether or not the data for verification D0 associated with the specified ID and the received data for verification DO match. Accordingly, for example, a load of processing is lessened as compared with a case where data for verification D0 that matches the received data for verification D0 is searched for. The account information is downloaded from the server 5. Accordingly, for example, a user is not requested to input account information in the initial biometric authentication (the authentication performed before the authentication is canceled due to an abnormality), and thus user's convenience can be improved.

The image processing apparatus 3 may perform the re-authentication by transmitting only an ID and a password (the account information) without transmitting the data for verification DO, unlike the above description. In this case, for example, a user is not requested to input account information in the initial authentication (biometric authentication performed before the authentication is canceled due to an abnormality), and thus user's convenience can be improved. On the other hand, in the re-authentication, an amount of communication can be reduced, and a burden on the server 5 can be lessened by using a password (by skipping biometric authentication).

Only the data for verification D0 may be transmitted or only the account information may be transmitted as described above, and as is understood from this, only the data for verification D0 or only the account information may be downloaded.

The image processing apparatus 3 deletes the downloaded data for verification DO and account information when a predetermined condition is satisfied. The predetermined condition may be any of various conditions. For example, the data for verification D0 and the like may be deleted when an event that triggers normal cancellation of authentication occurs.

For example, the data for verification D0 and the like may be deleted when the control unit 29 determines that probability that authentication is canceled due to an abnormality is low (e.g., in a case where the control unit 29 determines that communication is stable). The data for verification D0 and the like may be deleted when a predetermined period elapses from the download. Note that the elapse of the predetermined period may be regarded as one kind of condition on which it is determined that probability that authentication is canceled due to an abnormality is low.

FIG. 12 is a flowchart illustrating an example of a procedure of processing performed by the control unit 29 of the image processing apparatus 3 to realize the above operation.

This processing may be, for example, started immediately after success of initial authentication. Note, however, that the processing may be started when a predetermined condition is satisfied, for example, when the control unit 29 determines that communication is not stable after success of initial authentication.

In step ST51, the control unit 29 downloads the data for verification D0 and/or the account information from the server 5.

In step ST52, the control unit 29 determines whether or not abnormal cancellation of the authentication has occurred. In a case where a result of the determination is positive, the control unit 29 proceeds to step ST53, and in a case where the result of the determination is negative, the control unit 29 skips step ST53.

In step ST53, the control unit 29 performs re-authentication by using the data for verification D0 and/or the account information acquired in step ST51.

In step ST54, the control unit 29 determines whether or not a condition for deletion of the data for verification D0 and/or the account information acquired in step ST51 has been satisfied. In a case where a result of the determination is positive, the control unit 29 proceeds to step ST55, and in a case where the result of the determination is negative, the control unit 29 returns to step ST52.

In step ST55, the control unit 29 deletes the data for verification D0 and/or the account information acquired in step ST51 from all storage units (the RAM 43, the auxiliary storage device 45, and/or the like) in which the data for verification D0 and/or the account information are stored.

The determination as to whether or not abnormal cancellation of authentication has occurred (step ST52) may be performed as appropriate. For example, the control unit 29 may determine that abnormal cancellation has occurred when upload and/or download of data that needs authentication are not permitted by the server 5 although normal processing for canceling authentication has not been performed. For example, in an aspect in which the second example of the action is applied, the control unit 29 may determine that abnormal cancellation has occurred when communication through VPN connection is disabled although the VPN connection is not cut off through a normal procedure.

Note that although a case where abnormal cancellation of authentication has occurred has been described as an example, the downloaded data for verification D0 and/or account information may be used for a purpose that does not depend on abnormal cancellation of authentication.

For example, the description of FIG. 4 mentioned that a user name may be displayed on the display unit 35. In such an aspect, a downloaded ID may be displayed on the display unit 35 instead of or in addition to the user name.

For example, the description of FIG. 3 mentioned that re-authentication may be requested in accordance with a security level. In such an aspect, the user may be requested to input biological information and/or a password, and re-authentication may be performed in the image processing apparatus 3 (without the server 5) by using the downloaded data for verification D0 and/or account information.

As described above, the image processing apparatus 3 may download the data for verification D0 to be compared with the data for authentication D1 and account information from the external authentication apparatus (the server 5) and store the data for verification DO and the account information until a predetermined condition is satisfied.

In this case, for example, re-authentication can be requested from the server 5 without inputting biological information again, as illustrated with reference to FIG. 12. This improves user's convenience. Alternatively, for example, re-authentication can be performed in the image processing apparatus 3. This lessens a burden on the server 5 related to the re-authentication. For example, since the data for verification D0 and the account information are just stored until a predetermined condition is satisfied, probability that the data for verification D0 and the account information are improperly acquired by a third party thereafter is low. That is, security is increased.

### Specific Example or Variation of Registration of Data for Verification

FIG. 13 is a schematic view illustrating a variation of operation of registering the data for verification D0 in the server 5.

In steps ST1 to ST4 of FIG. 3, the data for verification D0 is transmitted from the image processing apparatus 3 to the server 5 and is recorded in the verification table DT0. On the other hand, in the example of FIG. 13, the data for verification D0 is transmitted from the terminal 9 to the server 5 and is recorded in the verification table DT0. Thereafter, as in steps ST5 to ST9 of FIG. 3, the data for authentication D1 is transmitted from the image processing apparatus 3 to the server 5, authentication is performed in the server 5, and information on an authentication result is transmitted from the server 5 to the image processing apparatus 3. Note that the terminal 9 may include a detection unit that reads biological information or may be connected to a detection unit. In the latter case, a combination of the terminal 9 and the detection unit may be regarded as a terminal.

In the verification table DT0 of FIG. 4, an ID and data for verification are associated on a one-to-one basis. On the other hand, in the verification table DT0 of FIG. 13, an ID and two or more pieces of data for verification (abbreviated as “1stVD” and “2ndVD”) can be associated. In the example illustrated in FIG. 13, “ID1” in the uppermost stage is associated with two pieces of data for verification, and other IDs are associated with one piece of data for verification.

The registration using the terminal 9 illustrated in FIG. 13 may be initial registration or may be additional registration or replacing registration performed after the initial registration.

The initial registration is operation of associating the data for verification D0 with an ID with which no data for verification D0 is associated. Note that the ID may be registered before the initial registration or need not be registered before the initial registration. Associating the data for verification D0 with an ID is specifically operation of storing the data for verification D0 in the verification table DT0, as is understood from the description given so far.

The additional registration is operation of associating another piece of data for verification D0 with an ID with which data for verification D0 has been associated, as illustrated in FIG. 13.

The replacing registration is operation of replacing data for verification DO associated with an ID with another piece of data for verification D0. This can reduce, for example, probability that authentication fails due to a change in data for authentication D1 caused by aging.

Note that the communication system 1 may permit only one of the image processing apparatus 3 and the terminal 9 to perform the initial registration or may permit both of the image processing apparatus 3 and the terminal 9 to perform the initial registration. The same applies to the additional registration and replacing registration. In the description given so far and the following description, the term “registration” may be interchangeable with any of the three types of registration, and the three types of registration may be interchangeable with one another, unless inconsistency or the like occurs.

In the verification table DT0 illustrated in FIG. 13, two or more pieces of data for verification D0 associated with one ID are basically of the same kind. For example, both of pieces of biological information related to the two pieces of data for verification are a fingerprint or an iris and is not a combination of fingerprint and iris. When biological information is processed to generate data for verification (data for authentication), an identical conversion method is used for two pieces of data for verification. In an aspect different from the aspect described here, different kinds of data for verification may be associated with one ID.

Two or more pieces of data for verification associated with one ID may be, for example, data for verification of two or more users who share an identical account (ID). In this case, biometric authentication service of high security can be offered to two or more users who share an identical account. For example, in a case where received data for authentication D1 matches any one of two or more pieces of data for verification associated with one account, the server 5 determines that authentication concerning the one account has succeeded.

Two or more pieces of data for verification associated with one ID may be data for verification of different portions of one user. For example, two pieces of data for verification may be data for authentication based on a fingerprint of an index finger and data for authentication based on a fingerprint of a middle finger. In this case, for example, in a case where authentication using one of the index finger and the middle finger cannot be performed due to injury or the like, authentication can be performed by using the other finger. In such operation, for example, in a case where received data for authentication D1 matches any one of two or more pieces of data for verification associated with one account, the server 5 determines that authentication concerning the one account has succeeded. Unlike the above case, the server 5 may determine that authentication has succeeded only in a case where both of authentication based on an index finger and authentication based on a middle finger succeed. In this case, security improves.

Two or more pieces of data for verification associated with one ID may be data for verification of one portion of one user. For example, both of two pieces of data for verification may be a fingerprint of an index finger. For example, in a case where received data for authentication D1 matches any one or two or more pieces of data for verification associated with one account, the server 5 determines that authentication concerning the one account has succeeded. As a result, for example, even if authentication based on one data for verification fails due to a change in biological information (from another perspective, data for authentication D1) caused by aging or a physical condition, the server 5 can succeed in authentication when authentication based on the other data for verification succeeds. For example, in a case where only one piece of data for verification is registered, probability that authentication fails improperly becomes high in a case where the data for verification includes an error. Such inconvenience is overcome by registering two or more pieces of data for verification.

Note that differences among the above three aspects, in which in a case where received data for authentication D1 matches any one of two or more pieces of data for verification associated with one account, the server 5 determines that authentication concerning the one account has succeeded, are mainly differences in manner of operation. That is, from a technical perspective, there may be no difference among the three aspects concerning operation and the like of the image processing apparatus 3 and/or the server 5. However, there may be a technical difference. For example, in a case where two or more pieces of data for verification associated with one ID are data for verification of one portion of one user, the server 5 may compare data for detection that has been already registered and new data for detection upon request of additional registration and may reject the additional registration in a case where a difference is too large.

Association of two or more pieces of data for detection with one ID may be, for example, realized by associating one or more pieces of data for detection by additional registration after associating one piece of data for detection by initial registration. In this case, for example, in the aspect in which two or more pieces of data for detection are data for detection of one portion of one user, two or more pieces of data for detection reflecting influence of aging or a physical condition are generated. However, two or more pieces of data for detection may be associated at the same time. For example, two or more pieces of data for detection may be associated in initial registration. In this case, for example, in the aspect in which the two or more pieces of data for detection are data for detection of one portion of one user, inconvenience of registering only data for detection having a large error is avoided.

FIG. 14 is a flowchart illustrating an example of a procedure of processing performed by a client 53 and the server 5 to perform registration (initial registration, additional registration, and/or replacing registration).

As has been already described, the registration may be performed by the image processing apparatus 3 or may be performed by the terminal 9. In view of this, the client 53 is illustrated as a higher concept in FIG. 14. Note that in the following description, the term “client 53” is interchangeable with a control unit of the client 53 unless inconsistency or the like occurs. The processing of FIG. 14 assumes an aspect in which the server 5 has account information including an ID and a password. The processing of FIG. 14 is, for example, started when a predetermined operation for giving an instruction to perform registration is made on the client 53.

In step ST61, the client 53 transmits a signal requesting registration of data for verification to the server 5. Note that this signal may be, for example, a signal requesting access to a web page for registration of data for verification or may be a signal different from such a signal.

In step ST62, the server 5 transmits a signal requesting an ID and a password to the client 53. The client 53 that has received this signal displays information (e.g., an image) requesting input of an ID and a password on a display unit. Note that this step may be, for example, a step of downloading data of a web page for input of an ID and a password into the client 53 or may be a step different from such a step.

In step ST63, the client 53 transmits input ID and password to the server 5.

In step ST64, the server 5 verifies the received account information by comparing a password associated with the received ID and the received password.

In step ST65, the server 5 notifies the client 53 of an authentication result. This step may be, for example, a step of downloading data of a web page showing the authentication result into the client 53 and displaying the web page or may be a step different from such a step. In a case where authentication succeeds, the web page showing the authentication result may display information prompting a user to input biological information.

Step ST1 and subsequent steps indicate processing performed in a case where authentication succeeds in step ST64. Steps ST1 to ST4 are basically same as and/or similar to steps ST1 to ST4 of FIG. 3. Although account information is transmitted together with data for verification in step ST3 in the description of FIG. 3, account information need not be transmitted in FIG. 14. Although the registration in step ST4 is initial registration in the description of FIG. 3, both of step ST4 of FIG. 3 and step ST4 of FIG. 14 may be any of initial registration, additional registration, and replacing registration.

The above processing may be changed as appropriate. For example, the authentication in steps ST62 to ST65 may be performed before the request for registration in step ST61. As is understood from the above description, the registration procedure may be a web procedure or may be a procedure using a different type of communication.

Steps ST62 to ST65 are processing for reducing probability that a third party improperly registers data for verification. Such processing is not limited to the authentication using a password and can be any of various kinds of processing.

For example, another authentication element may be used instead of (or in addition to) a password (from another perspective, key input). This authentication element can be, for example, an authentication card or can be biological information of a kind different from biological information of data for verification to be registered in step ST4. In an aspect in which step ST4 is replacing registration or additional registration, biometric authentication using data for verification registered by initial registration may be performed instead of (or in addition to) the authentication using a password and the like.

For example, an e-mail including an address of a web page (with an expiration date) for registration and a temporary password issued by the server 5 may be transmitted from the server 5 to an e-mail address that is registered in advance in association with account information in the server 5. Then, the server 5 may perform authentication using the temporary password in response to request of access to the web page from the client 53 and perform steps ST1 to ST4 when the authentication succeeds.

As described above, in the communication system 1, data for verification D0 based on biological information detected by the user's terminal 9 may be transmitted from the terminal 9 to the server 5 when data for verification D0 to be compared with data for authentication D1 in authentication performed by the external authentication apparatus (the server 5) is registered in the server 5.

In this case, for example, the client 53 that registers the data for verification D0 and the image processing apparatus 3 that performs biometric authentication may be different communication apparatuses, and therefore user's convenience improves. For example, the registration work may take a long time, for example, because the user is unfamiliar with the work. If the registration work is performed for a long time in the image processing apparatus 3, other users of the image processing apparatus 3 suffer inconvenience. Probability that such inconvenience occurs is reduced. In general, the input output unit 21 of the image processing apparatus 3 is not suitable for a web procedure. In a case where a PC or a smartphone is used as the client 53, it is easier to perform the web procedure. The initial registration is more likely to require a complicated procedure than the additional registration or replacing registration, for example, because input of information concerning a user is requested. Therefore, in a case where the initial registration can be performed by the user's terminal 9, the above effect improves.

In the communication system 1, at least one of additional registration or replacing registration of data for verification D0 to be compared with data for authentication D1 in authentication performed by the external authentication apparatus (the server 5) may be performed for an identical account by a procedure using communication established through authentication (a password in FIG. 14) different from authentication using the data for authentication D1.

In this case, for example, various effects such as reducing probability that authentication fails due to a change in biological information caused by aging and/or a physical condition are produced, as has been already described. Since the replacing registration or additional registration is performed by using authentication different from authentication using data for authentication D1, the registration can be performed securely, for example, even in a case where the data for verification D0 registered earlier has already caused inconvenience. The method using authentication different from authentication using data for authentication D1 is also applicable to deletion of data for verification D0.

### Example of Method for Generating Data for Authentication

FIG. 15 is a schematic view illustrating a specific example of generation of data for verification (step ST2 of FIG. 3), generation of data for authentication (step ST6 of FIG. 3), and the like.

In this schematic view, for convenience of description, a method for generating data for verification D0 and data for authentication D1 for only one user is illustrated. For example, as illustrated in the middle stage, association of data for verification D0 with one ID in the verification table DT0 is expressed by drawing one piece of data for verification D0.

As has been already described, registration (generation of data for verification) may be performed not only by the image processing apparatus 3, but also by another communication apparatus (e.g., the terminal 9). For convenience of description, the image processing apparatus 3 is taken as an example. The registration may be any of initial registration, replacing registration, and additional registration, as has been already mentioned.

The uppermost stage of FIG. 15 schematically illustrates operation related to the registration in steps ST1 to ST3 of FIG. 3 (or FIG. 14). When biological information D11 is acquired by the detection unit 25, a conversion unit 29b of the control unit 29 converts the biological information D11 into data for verification D0 by using data for conversion D9 (referred to as a “parameter” because of restriction of a paper size) stored in a non-volatile storage device (e.g., the auxiliary storage device 45) of the image processing apparatus 3. The data for verification D0 is transmitted to the server 5 (corresponding to step ST3 of FIG. 3).

The middle stage of FIG. 15 schematically illustrates operation related to the registration in step ST4 of FIG. 3. The server 5 causes received data for verification D0 to be stored in the verification table DT0. That is, the received data for verification D0 is registered by associating an ID and the data for verification D0. As illustrated in the middle stage of FIG. 15, the image processing apparatus 3 may delete the biological information D11 and the data for verification D0 from a storage unit (from both of a non-volatile storage unit and a volatile storage unit) of the image processing apparatus 3 after transmitting the data for verification D0. On the other hand, the data for conversion D9 is kept stored in the auxiliary storage device 45.

The lowermost stage of FIG. 15 schematically illustrates operation related to the authentication in steps ST5 to ST9 of FIG. 3. When biological information D11 is acquired by the detection unit 25, the conversion unit 29b converts the biological information D11 into data for authentication D1 by using the data for conversion D9 stored in the auxiliary storage device 45. The data for authentication D1 is generated by a same algorithm by using the same data for conversion D9 as that used to generate the data for verification D0. Accordingly, in a case where the biological information D11 used to generate the data for verification D0 and the biological information D11 used to generate the data for authentication D1 are the same, the data for verification D0 and the data for authentication D1 are the same.

The data for authentication D1 generated by the image processing apparatus 3 is transmitted to the server 5 (corresponding to step ST7 of FIG. 3). The server 5 performs verification by using the received data for authentication D1 and the registered data for verification D0 (corresponding to step ST8 of FIG. 3) and notifies the image processing apparatus 3 of an authentication result (corresponding to step ST9 of FIG. 3). Note that the image processing apparatus 3 may delete the biological information D11 and the data for authentication D1 from a storage unit (from both of the non-volatile storage unit and the volatile storage unit) of the image processing apparatus 3 after transmitting the data for authentication D1, as in the case of transmission of the data for verification D0.

As described above, in the example illustrated in FIG. 15, the biological information D11 itself is not transmitted, and the data for verification D0 and the data for authentication D1 obtained by conversion using the data for conversion D9 are transmitted. The server 5 does not hold the biological information D11 itself. The conversion is, in other words, encryption. Accordingly, probability that the biological information D11 is improperly acquired from a network and/or the server 5 is reduced. In a case where the data for verification D0 is improperly acquired from the server 5, the data for verification D0 stored in the server 5 is deleted, and data for verification D0 is registered again by using new data for conversion D9. This makes it possible to continue biometric authentication of a legitimate user while reducing probability that a third party that improperly acquired the old data for verification D0 is authenticated by the server 5.

The data for conversion D9 may be, for example, set for each user. This improves security. The data for conversion D9 may be recorded in a non-volatile storage unit, such as a USB memory, that is attachable to and detachable from the image processing apparatus 3. This allows a user to generate the data for verification D0 and/or the data for authentication D1 by using the data for conversion D9 in any image processing apparatus 3.

A specific aspect of the data for conversion D9 and a specific algorithm of conversion (encryption) are not limited in particular. For example, the conversion may be processing for converting image data of biological information into a random image by using a parameter. The data for conversion (e.g., a parameter) may be converted together with biological information and influence the data for verification D0 and the data for authentication D1 or may be assigned to a variable included in the conversion algorithm. The data for conversion may be, for example, a combination of various numerical values.

A method different from the above method may be used to convert biological information into data for authentication by using data for conversion. For example, a method similar to challenge and response authentication may be used. Specifically, for example, the following method may be used.

The verification table DT0 stores therein in advance biological information D11 itself as data for verification D0 associated with an ID. The image processing apparatus 3 transmits an authentication request to the server 5. Upon receipt of the authentication request, the server 5 generates a challenge having contents (e.g., a value) that varies from one authentication request to another on the basis of a random number or the like and transmits the challenge to the image processing apparatus 3 that transmitted the authentication request. The image processing apparatus 3 converts biological information D11 into data for authentication D1 by using the received challenge as the data for conversion D9 (corresponding to step ST5 and ST6). Then, the image processing apparatus 3 transmits the data for authentication D1 together with an ID. Note that the ID may be transmitted when the authentication request is transmitted.

Then, the server 5 that has received the ID and the data for authentication D1 extracts biological information D11 associated with the received ID by referring to the verification table DT0. Next, the server 5 converts the extracted biological information D11 by a same conversion algorithm as a conversion algorithm in the image processing apparatus 3 by using the challenge transmitted earlier. In a case where the extracted biological information D11 is identical to the biological information D11 detected in the image processing apparatus 3, the data obtained by the conversion matches the received data for authentication. In this way, authentication is performed. Note that the conversion algorithm may be a conversion algorithm using a hash function similar to typical challenge and response authentication or may be a conversion algorithm different from such a conversion algorithm.

In the aspect similar to the challenge and response, the biological information D11 is stored in the server 5, unlike the aspect of FIG. 15. However, since the data for authentication DI is not the biological information D11 itself, probability that the biological information D11 is improperly acquired from a network by transmission of the data for authentication D1 is reduced, as in the aspect of FIG. 15. As is understood from the aspect similar to the challenge and response, when the data for verification D0 compared with the data for authentication D1 is mentioned, the data for verification D0 (the biological information D11 itself) need not be compared with the data for authentication D1 (data obtained by converting the biological information D11) as it is.

As described above, the data for authentication D1 may be created by converting the biological information D11 by using the data for conversion D9 stored in a storage unit (e.g., the auxiliary storage device 45) of the image processing apparatus 3.

In this case, for example, the data for authentication D1 obtained by converting the biological information D11 is transmitted instead of transmitting the biological information D11 as it is. Accordingly, it is not the biological information D11 itself but the data for authentication D1 that is improperly acquired by a third party over a network. As a result, probability that the biological information D11 itself leaks is reduced.

### Specific Example or Variation of Configuration and Operation of Detection Unit

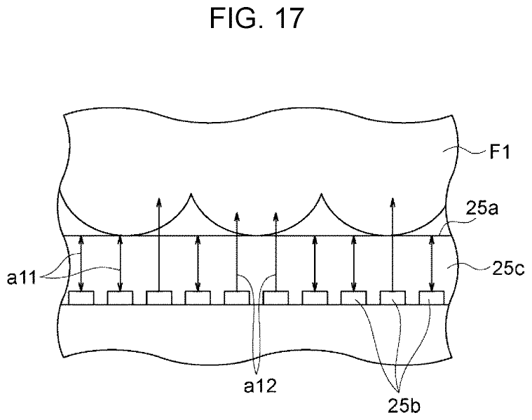

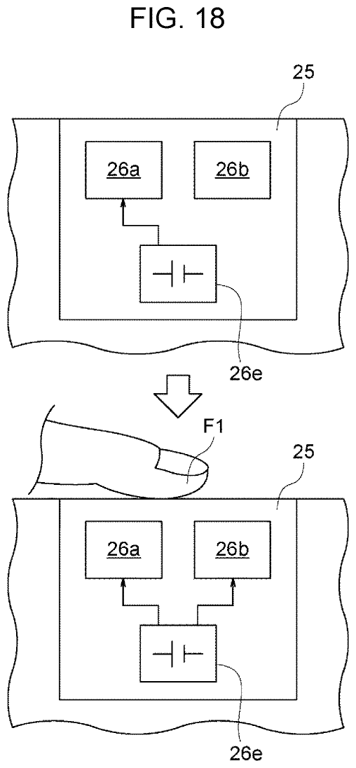

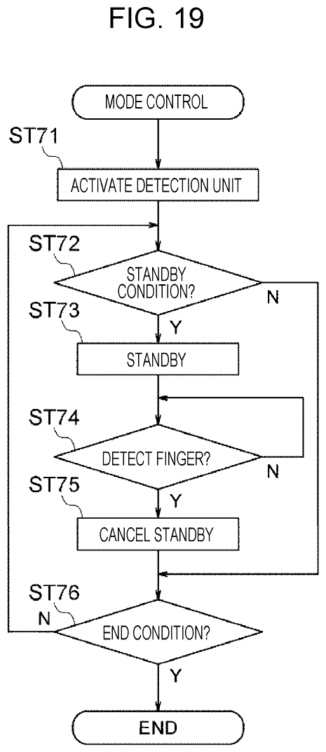

Description regarding a specific example or a variation of configuration and operation of the detection unit will be basically given below in the following order:
A specific example or a variation concerning a position and the like of the detection unit (FIG. 16).
A configuration example of an ultrasonic detection unit (FIG. 17).
An example of operation related to a standby mode of the detection unit (FIGS. 18 and 19).

(Specific Example or Variation Concerning Position and the Like of Detection Unit) FIG. 16 is a schematic perspective view illustrating a configuration of a portion of an upper part of the image processing apparatus 3D including the detection unit 25. Note that description of the image processing apparatus 3D and the detection unit 25 may be applied to the image processing apparatuses 3A to 3C and others illustrated in FIG. 1 unless otherwise specified and unless inconsistency or the like occurs.

In FIG. 16, the image processing apparatus 3D is in such a state that a lid 21a of the scanner 21 is lifted so that a reading surface 21b (an upper surface of a glass plate) of the scanner 21 is exposed. The lower left region in FIG. 16 is an enlarged view of the detection unit 25. In FIG. 16, an orthogonal coordinate system D1-D2-D3 is added. The D3 axis is, for example, an axis parallel with a vertical direction. The +D3 side is, for example, an upper side in the vertical direction.

The image processing apparatus 3D includes a body 17a of the housing 17, a support mechanism 17b supported on the body 17a, and a panel 17c supported on the support mechanism 17b. The panel 17c includes at least a part of the input output unit 23 and the detection unit 25. The panel 17c is supported on the support mechanism 17b so that a position and/or an orientation thereof are changeable. Note that the detection unit 25 may be supported on the support mechanism 17b separately from the input output unit 23, unlike the example illustrated in FIG. 16.

The panel 17c is located on the −D2 side relative to the scanner 21, and a surface of the panel 17c that receives a user's operation and input of biological information faces the +D3 side (upper side) and the −D2 side. From another perspective, the detection unit 25 is located on the −D2 side relative to the scanner 21. The −D2 side can be rephrased as a side where the input output unit 23 (the operation unit 33 and/or the display unit 35) is located relative to the scanner 21. In a case where the detection unit 25 is thus located, it is, for example, easy to input biological information.

A direction in which the position and/or orientation of the panel 17c (from another perspective, the detection unit 25) is changeable may be freely set. For example, movement of the panel 17c may include any component among parallel movement in the D1 direction, parallel movement in the D2 direction, parallel movement in the D3 direction, rotary movement about the D1 axis, rotary movement about the D2 axis, and rotary movement about the D3 axis. In FIG. 16, arrow a1 indicates that the panel 17c is rotatable (from another perspective, swingable) about the D1 axis. The panel 17c may be movable in the up-down direction (the D3 direction) in addition to this swinging.

A configuration of the support mechanism 17b for realizing the above movement may be an appropriate one. For example, the support mechanism 17b may include a joint rotatable about a predetermined axis (e.g., about an axis parallel with the D1 axis), a universal joint swingable in any direction, and/or a slider movable parallel with a predetermined axis direction (e.g., the D3 direction). Although the support mechanism 17b has a columnar outer shape in FIG. 16, the support mechanism 17b is not limited to one having such an outer shape and may be, for example, one having a wall-shaped outer shape.

The detection unit 25 has, for example, a detection surface 25a and detects biological information from a side which the detection surface 25a is located. In FIG. 16, the detection unit 25 that reads a fingerprint of a finger placed on the detection surface 25a is illustrated as an example of the detection unit 25. However, the description of FIG. 16 may be applied to the detection unit 25 that detects a different kind of biological information unless inconsistency or the like occurs. For example, the detection surface 25a may be a surface to which light from a different kind of biological information is input or may be a surface to which sound (an ultrasonic wave or user's voice) is input.

A position of the detection surface 25a of the detection unit 25 may be set as appropriate. In the example illustrated in FIG. 16, the detection surface 25a is located at a position higher than the reading surface 21b of the scanner 21. Such a positional relationship may be applied to an aspect in which the detection unit 25 is unmovable with respect to the housing 17 as in the image processing apparatuses 3A to 3C illustrated in FIG. 1. In an aspect in which the detection unit 25 is movable up and down as in the image processing apparatus 3D, the detection surface 25a may be located at a position higher than the reading surface 21b at least when the detection unit 25 is at a highest position. Needless to say, the detection surface 25a may be located at a position lower than the reading surface 21b.

An orientation of the detection surface 25a of the detection unit 25 may be set as appropriate. In the example illustrated in FIG. 16, the detection surface 25a is inclined with respect to the reading surface 21b of the scanner 21. More specifically, a normal to the reading surface 21b is parallel with the D3 axis (vertical axis), and a normal to the detection surface 25a is inclined toward the −D2 side with respect to the D3 axis. In the example illustrated in FIG. 16, the −D2 side is a side where the detection unit 25 is located with respect to the scanner 21. Such an orientation may be applied to an aspect in which the detection unit 25 is unmovable with respect to the housing 17 as in the image processing apparatuses 3A to 3C illustrated in FIG. 1. In an aspect in which the orientation of the detection unit 25 is changeable as in the image processing apparatus 3D, the detection surface 25a may be inclined with respect to the reading surface 21b in at least a partial angular range. Needless to say, the detection surface 25a may be parallel with the reading surface 21b.

As has been already described, such a detection unit 25 may be one that performs scan or may be one that does not perform scan. In FIG. 16, arrow a3 expresses that scan is performed in a direction of arrow a3. For example, in a case where the detection unit 25 reads a fingerprint, acquisition of a linear one-dimensional image extending along the D1 direction is sequentially performed in a direction indicated by arrow a3. In this case, a finger F1, which is a subject, may move in the direction indicated by arrow a3 or an imaging unit (not illustrated) that images the finger F1 may move in the direction indicated by arrow a3. Note that acquisition of a linear one-dimensional image extending along the D1 direction is, in other words, acquisition of information at a plurality of positions on a line along the D1 direction.

A direction of the scan may be an appropriate direction. In the example of FIG. 16, the scan direction indicated by arrow a3 is different from a scan direction (the D1 direction) of the scanner 21 indicated by arrow a2 in plan view (viewed parallel in the D3 direction). More specifically, these scan directions are orthogonal to each other.

Note that in the scanner 21, for example, an imaging unit 21c having a length in the D2 direction performs scanning by moving in the D1 direction below the glass plate that constitutes the reading surface 21b. The imaging unit 21c includes, for example, a plurality of imaging elements (not illustrated) arranged in the D2 direction. The imaging unit 21c may further include an appropriate optical element (e.g., a lens and/or a mirror) to prolong an optical path from the reading surface 21b to the imaging elements or reduce an image on the reading surface 21b and project the reduced image onto the plurality of imaging elements.

The detection surface 25a of the detection unit 25 is desirably provided at a position recessed from a surrounding surface (e.g., a surface of the housing 17). According to this structure, damage of the detection surface 25a can be made less likely to occur, and detection accuracy can be improved.

The detection surface 25a may be antiviral-treated. For example, the detection surface 25a is a plate-shaped member, and a material of this plate-shaped member may contain a component that exhibits an antiviral effect. For example, the detection surface 25a is a film that covers the plate-shaped member or the like and the film may contain a component that exhibits an antiviral effect. Examples of the component that exhibits an antiviral effect include a monovalent copper compound and silver. A target virus may be any kind of virus. The antiviral property of the detection surface 25a may be, for example, an antiviral activity value of 2.0 or more in a test according to International Organization for Standardization (ISO) 21702. The detection surface 25a may exhibit an antibacterial effect in addition to or instead of the antiviral effect.

As described above, the orientation of the detection unit 25 may be variable.

In this case, for example, by changing the orientation of the detection unit 25 in accordance with a body size of a user, input of biological information is made easy. For example, in a case where authentication fails due to influence of natural lighting or artificial lighting on biological information, success of authentication can be achieved by performing detection again after changing the orientation of the detection unit 25.

The detection unit 25 may have the detection surface 25a and detect biological information from a direction which the detection surface 25a faces. The detection surface 25a may be inclined with respect to the reading surface 21b of the scanner 21.

In this case, for example, input of biological information can be made easy. This is because although the reading surface 21b typically faces an upper side in the vertical direction so that a document does not fall off from the reading surface 21b, the detection surface 25a that faces an upper side in the vertical direction is not necessarily suitable for input of biological information.

The detection surface 25a may be located at a position higher than the reading surface 21b of the scanner 21.

In this case, for example, input of biological information can be made easy. Specifically, for example, in an aspect in which biological information detected by the detection unit 25 is a retina or an iris, it is easier for a user to bring his or her eye close to the detection unit 25, and therefore operability improves. Note that in a case where the detection surface 25a is located at a position lower than the reading surface 21b, for example, probability that the detection unit 25 hinders work of placing a document on the reading surface 21b is reduced.

The scanner 21 may acquire a two-dimensional image by sequentially performing acquisition of a one-dimensional image extending along a first direction (the D2 direction) in a second direction (the D1 direction) orthogonal to the D2 direction. The detection unit 25 may acquire biological information by sequentially performing acquisition of information at a plurality of positions on a line extending along a third direction (the D1 direction) in a fourth direction (the direction indicated by arrow a3) orthogonal to the D1 direction. The second direction (the D1 direction) and the fourth direction (the direction indicated by arrow a3) may be different.

In this case, for example, it is easy to make a range in which biological information is read large. Specifically, the scanner 21 is typically large in a direction (the second direction: the D1 direction) in which the imaging unit 21c moves, and therefore the units of the image processing apparatus 3 such as the input output unit 23 are arranged assuming that a user is located on one side (the −D2 side) with respect to the image processing apparatus 3 in a direction (the first direction: the D2 direction) that crosses the D1 direction. As a result, for example, in a case where biometric authentication uses a fingerprint or a blood vessel of the finger F1, probability that a user is forced to be in an uncomfortable posture is reduced by performing fingerprint authentication so that the finger F1 is located along the D2 direction. In a case where the detection unit 25 performs scan in the D2 direction while the finger F1 is located in this way, the fingerprint or the blood vessel of the finger can be imaged over a wide range by the imaging unit whose length in the D1 direction is relatively short.

In a case where a blood vessel of a finger is imaged by the detection unit 25 (e.g., in a case of finger vein authentication), an irradiation unit that emits light (e.g., near infrared ray) and the detection surface 25a that detects light absorption by and transmission through a finger (blood vessel) may be provided in a hole (non-through hole) into which a finger can be inserted.

### Configuration Example of Ultrasonic Detection Unit)

FIG. 17 is a schematic cross-sectional view illustrating a specific example of the ultrasonic detection unit 25. However, hatching indicating a cross section is omitted for the purpose of illustrating arrows indicating ultrasonic waves.

The detection unit 25 is, for example, for detecting a fingerprint. In other words, the detection unit 25 is for detecting irregularities on a body surface. The finger F1 is placed on the detection surface 25a of the detection unit 25. FIG. 17 is an enlarged view of the detection surface 25a and a part of vicinity of the detection surface 25a. Irregularities on a lower surface of the finger F1 are raised parts and recessed parts that constitute a fingerprint.

The detection unit 25 has, for example, a plurality of ultrasonic elements 25b that is arranged along the detection surface 25a. The plurality of ultrasonic elements 25b is covered with a medium layer 25c. A surface of the medium layer 25c constitutes the detection surface 25a. A difference between acoustic impedance of a material of the medium layer 25c and acoustic impedance of a body surface (skin) is smaller than a difference between acoustic impedance of the material of the medium layer 25c and acoustic impedance of air. For example, the acoustic impedance of the material of the medium layer 25c and the acoustic impedance of the body surface are approximately equal.

In such a configuration, the plurality of ultrasonic elements 25b transmits an ultrasonic wave toward the detection surface 25a. In a region where the detection surface 25a and the finger F1 are not in contact, the ultrasonic wave is reflected (an intensity of a reflected wave is relatively strong) because the acoustic impedance of the detection surface 25a (the medium layer 25c) and the acoustic impedance of the air are different (a difference is relatively large), as indicated by arrows all. The reflected wave is received by the ultrasonic elements 25b. On the other hand, in a region where the detection surface 25a and the finger F1 are in contact, the ultrasonic wave transmits to an inside of the finger F1 without being reflected (an intensity of a reflected wave is relatively weak) since the acoustic impedance of the detection surface 25a and the acoustic impedance of the finger F1 are similar (a difference is relatively small), as indicated by arrows a12.

Therefore, in a case where the ultrasonic elements 25b receive a reflected wave reflected by the detection surface 25a (an intensity of the reflected wave is strong), the ultrasonic elements 25b can detect that detection regions thereof correspond to recessed parts of a fingerprint. Conversely, in a case where the ultrasonic elements 25b fail to receive a reflected wave reflected by the detection surface 25a (an intensity of the reflected wave is weak), the ultrasonic elements 25b can detect that detection regions thereof correspond to raised parts of a fingerprint. Note that the configuration illustrated in FIG. 17 can detect biological information (e.g., a palm shape) indicated by irregularities of a body surface other than a fingerprint, as is understood from the above description.

The plurality of ultrasonic elements 25b may be arranged one-dimensionally or two-dimensionally so that the number of ultrasonic elements 25b in the left-right direction of FIG. 17 is larger than the number of ultrasonic elements 25b in a direction perpendicular to a surface of the paper on which FIG. 17 is drawn. The plurality of ultrasonic elements 25b may acquire a two-dimensional image by mechanically moving in the direction perpendicular to the surface of the paper on which FIG. 17 is drawn and thus performing scan. Alternatively, the plurality of ultrasonic elements 25b may be arranged two-dimensionally in the left-right direction of FIG. 17 and the direction perpendicular to the surface of the paper on which FIG. 17 is drawn and may acquire a two-dimensional image by electronic scan. Alternatively, the plurality of ultrasonic elements 25b may be arranged two-dimensionally in a region equivalent to a range where a fingerprint is read and acquire a two-dimensional image.

As described above, the detection unit 25 may detect irregularities of a user's body surface by transmitting and receiving an ultrasonic wave.

In this case, for example, influence of natural lighting and/or artificial lighting around the image processing apparatus 3 on input of biological information is reduced. That is, influence of an environment around the image processing apparatus 3 on authentication is reduced, and accuracy of authentication improves. As a result, for example, the image processing apparatus 3 can be placed in a dark place, and influence of lighting on scanning or the like can be reduced.

### Example of Operation Related to Standby Mode of Detection Unit

FIG. 18 is a schematic view for explaining an activation mode and a standby mode of the detection unit 25. Note that in FIG. 18, the detection unit 25 that reads a fingerprint of the finger F1 is illustrated as an example of the detection unit 25. The description given here may be applied to the detection unit 25 that detects a different kind of biological information unless inconsistence or the like occurs.

As illustrated in FIG. 18, the detection unit 25 may be switchable between an activation mode (the lower stage of FIG. 18) and a standby mode (the upper stage of FIG. 18). The activation mode is, for example, a state where biological information is detectable and includes an operation state before start of detection and an operation state during detection. Note that the standby mode is a state where electric power consumption is smaller than in the activation mode (e.g., the operation state before start of detection). The standby mode is sometimes called a sleep mode or the like.

The activation mode and the standby mode can be described as follows. The detection unit 25 includes a first drive unit 26a, a second drive unit 26b, and a power supply control unit 26e. In the activation mode, electric power is supplied from the power supply control unit 26e to the first drive unit 26a and the second drive unit 26b, as indicated by the arrows in the lower stage of FIG. 18. On the other hand, in the standby mode, electric power is supplied from the power supply control unit 26e only to the first drive unit 26a, as indicated by the arrow in the upper stage of FIG. 18.

The first drive unit 26a, the second drive unit 26b, and the power supply control unit 26e may be hardware elements or may be elements combining hardware and software. For example, the first drive unit 26a may be a non-volatile memory. The second drive unit 26b may be a CPU or may be one or some (e.g., a clock) of a plurality of functional units constructed by execution of a program by a CPU in the activation mode.

The activation mode and the standby mode can also be described as follows. In a case where a user tries to input biological information while the detection unit 25 is in the standby mode, the detection unit 25 shifts from the standby mode to the activation mode and then starts detection of biological information. On the other hand, in a case where a user tries to input biological information while the detection unit 25 is in the activation mode, the standby mode does not occur before detection of biological information. From another perspective, a period needed until detection of biological information starts (or ends) in a case where a user tries to input biological information in the standby mode is longer than a period needed until detection of biological information starts (or ends) in a case where a user tries to input biological information in the activation mode.

A user may be notified of whether a current mode of the detection unit 25 is the activation mode or the standby mode. A specific aspect of the notification can be any aspect.

For example, in FIG. 16 described earlier, the detection unit 25 includes an indicator light 25d. The indicator light 25d is, for example, adjacent to the detection surface 25a. An On state of the indicator light 25d may indicate the activation mode, and an Off state of the indicator light 25d may indicate the standby mode. Alternatively, in an aspect in which the display unit 35 of the image processing apparatus 3 can display any image, the activation mode and the standby mode may be indicated by a character or a figure.

FIG. 19 is a flowchart illustrating an example of a predetermined procedure for controlling switching of an operation state (mode) of the detection unit 25. This processing starts, for example, when the image processing apparatus 3 is powered on.

In step ST71, the control unit 29 performs processing for activating the detection unit 25. In this processing, for example, in the detection unit 25, a CPU executes a program stored in a ROM and/or an auxiliary storage device, and thereby a control unit of the detection unit 25 directly related to control of an element (e.g., the imaging element or the ultrasonic elements 25b) in the detection unit 25 is constructed. By activation of the detection unit 25, the detection unit 25 shifts to the activation mode described with reference to the lower stage of FIG. 18.

Note that the CPU, the ROM, the auxiliary storage device, and the control unit of the detection unit 25 may be grasped as a part of the CPU 39, a part of the ROM 41, a part of the auxiliary storage device 45, and a part of the control unit 29 illustrated in FIG. 2, as has been already described. Roles of the CPU, the ROM, the auxiliary storage device, and the control unit in the detection unit 25 and roles of the CPU 39, the ROM 41, the auxiliary storage device 45, and the control unit 29 may be set as appropriate, and need not be clearly distinguishable. In the following description, for convenience of description, it is assumed that a subject that performs processing is the control unit 29.

In step ST72, the control unit 29 determines whether or not a standby condition has been satisfied. In a case where a result of the determination is positive, the control unit 29 proceeds to step ST73 to shift the detection unit 25 into the standby mode. On the other hand, in a case where the result of the determination is negative, the control unit 29 proceeds to step ST76 to maintain the activation mode while skipping steps ST73 to ST75.

The standby condition may be set as appropriate. For example, the standby condition may be a condition that the image processing apparatus 3 is not used for a predetermined period, a condition that the detection unit 25 is not used for a predetermined period, and/or a condition that a user makes a predetermined operation on the operation unit 33.

In step ST73, the control unit 29 shifts the detection unit 25 into the standby mode. In step ST74, the control unit 29 determines whether or not a predetermined condition for canceling the standby mode has been satisfied. In a case where a result of the determination is positive, the control unit 29 proceeds to step ST75, in which the standby mode is canceled, and in a case where the result of the determination is negative, the standby mode is continued (repeats step ST74).

The condition for canceling the standby mode in step ST74 may be set as appropriate. FIG. 19 illustrates an aspect in which whether or not a finger has been placed on the detection unit 25 is determined. Alternatively, for example, the standby mode may be canceled when a predetermined operation (e.g., pressing of the button 33a or touch of a finger) is made on the operation unit 33 and/or when execution of a task (e.g., printing) that requires biometric authentication is requested by a user.

In step ST76, the control unit 29 determines whether or not a condition for ending the processing illustrated in FIG. 19 has been satisfied. The condition may be, for example, identical to a condition on which activation of the image processing apparatus 3 is ended or may be a condition that a predetermined operation is made on the operation unit 33. In a case where a result of the determination is positive, the control unit 29 ends the processing of FIG. 19 after performing processing (not illustrated) for ending activation of the detection unit 25, and in a case where the result of the determination is negative, step ST71 is performed again.

The detection of a finger in step ST74 may be realized as appropriate. For example, to realize the detection of a finger in step ST74, at least one element (e.g., imaging element or ultrasonic element) for detecting biological information may perform operation that consumes less electric power than detection of biological information. For example, only one or some of the plurality of ultrasonic elements 25b illustrated in FIG. 17 may transmit and receive an ultrasonic wave to realize the detection of a finger. Alternatively, an element that performs scan when acquiring biological information may detect a finger by acquiring information without performing scan. The detection of a finger may be realized by a sensor provided separately from an element that detects biological information. Although detection of a finger has been taken as an example, the same applies to a case where other kinds of biological information (e.g., a face, a blood vessel, an iris, or a retina) are detected.

The activation of the detection unit 25 in step ST71 may be started or ended at an appropriate time in relation to various kinds of operation of the image processing apparatus 3. For example, in the image processing apparatus 3, prior operation is performed before execution of printing and/or scanning by the image processing unit 31 for the purpose of improvement in image quality, speed-up of printing, and/or the like. Activation of the detection unit 25 may be, for example, ended before end of the prior operation. Accordingly, for example, at least a part of the prior operation is performed during authentication, and overall processing can be efficiently performed. In this case, activation of the detection unit 25 may be performed in parallel with the prior operation or may be performed before the prior operation.

Examples of the prior operation include the following. In a case where the printer 19 is an inkjet type, nozzle cleaning for cleaning a surface where a nozzle for ejecting ink is provided is sometimes performed before printing. The nozzle cleaning is an example of the prior operation. The printer 19 and/or the scanner 21 are sometimes preheated before printing or scanning to make image quality immediately after start of printing or immediately after start of scanning similar to image quality at a later time. Such preheating is an example of the prior operation.

As described above, the biological information may be a fingerprint. The standby mode of the detection unit may be canceled when a user's finger is placed on the detection unit 25.

In this case, a user's action for inputting biological information also serves as a user's action for canceling the standby mode, and therefore user's convenience improves. The standby mode can be canceled by using a part of a function for detecting biological information, and the number of constituent elements can be reduced.

The technique according to the present disclosure is not limited to the above embodiment and may be performed in various aspects.

For example, the image processing apparatus may be an apparatus having only a printing function (i.e., a printer in a narrow sense) or may be an apparatus having only a scanner function (i.e., a scanner in a narrow sense) instead of an MFP including a printer and a scanner. Note that the MFP may be regarded as a printer (in a broad sense) or a scanner (in a broad sense).

1. An image processing apparatus comprising:
an image processing unit including at least one of a printer or a scanner;
a detection unit that detects user's biological information;
a communication unit that transmits data for authentication based on the biological information detected by the detection unit to a server being external and receives a result of biometric authentication using the data for authentication from the server; and
a control unit that, based on the result of biometric authentication, gives an instruction for at least one of restriction or cancellation of restriction on functions relevant to the image processing unit and gives an instruction to perform an action relevant to the image processing unit and the communication unit for each user.

2. The image processing apparatus according to claim 1, wherein
the control unit gives an instruction to cancel restriction of a function relevant to the image processing unit on a basis of the result of biometric authentication.

3. The image processing apparatus according to claim 1, wherein
the control unit enables at least one of transmission or reception of image data through VPN connection established on a basis of the result of biometric authentication.

4. The image processing apparatus according to claim 1, further comprising a human sensor,
wherein when the human sensor detects that the user has moved away, authentication of the user is canceled after end of operation of the image processing unit.

5. The image processing apparatus according to claim 1, further comprising a reset button,
wherein authentication of the user is canceled when the reset button is held down.

6. The image processing apparatus according to claim 1, further comprising a display unit,
wherein when the authentication using the data for authentication fails, at least one of information prompting the user to perform detection using the detection unit again or information inquiring whether to switch to authentication different from the authentication using the data for authentication is displayed on the display unit.

7. The image processing apparatus according to claim 1, wherein
the biological information is a fingerprint, and a standby mode of the detection unit is canceled when a finger of the user is placed on the detection unit.

8. The image processing apparatus according to claim 1, further comprising a display unit,
wherein a menu screen of the display unit is set for each user on a basis of the result of biometric authentication.

9. The image processing apparatus according to claim 1, further comprising a display unit,
wherein user information and authority information are displayed on the display unit on a basis of the result of biometric authentication.

10. The image processing apparatus according to claim 1, wherein
data for verification to be compared with the data for authentication and account information are downloadable and are storable until a predetermined condition is satisfied.

11. The image processing apparatus according to claim 1, further comprising a storage unit,
wherein the data for authentication is created by converting the biological information by using data for conversion stored in the storage unit.

12. The image processing apparatus according to claim 1, wherein
an orientation of the detection unit is variable.

13. The image processing apparatus according to claim 1, comprising the scanner,
wherein the detection unit has a detection surface and detects the biological information from a direction which the detection surface faces, and
the detection surface is inclined with respect to a reading surface of the scanner.

14. The image processing apparatus according to claim 1, comprising the scanner that acquires a two-dimensional image by sequentially performing acquisition of a one-dimensional image extending along a first direction in a second direction orthogonal to the first direction,
wherein
the detection unit acquires the biological information by sequentially performing acquisition of information at a plurality of positions on a line extending along a third direction in a fourth direction orthogonal to the third direction, and
the second direction and the fourth direction are different.

15. The image processing apparatus according to claim 1, wherein
the detection unit detects irregularities on a body surface of the user by transmitting and receiving an ultrasonic wave.

16. A communication system comprising:
an image processing apparatus including an image processing unit including at least one of a printer or a scanner, a detection unit that detects user's biological information, a communication unit that transmits data for authentication based on the biological information detected by the detection unit, and a control unit that gives an instruction to perform an action relevant to the image processing unit and the communication unit; and
a server that receives the data for authentication from the image processing apparatus and performs biometric authentication, the server being external from a perspective of the image processing unit,
wherein the control unit gives an instruction for at least one of restriction or cancellation of restriction on functions relevant to the image processing unit and gives the instruction to perform the action on a basis of a result of biometric authentication of the server for each user.

17. The communication system according to claim 16, wherein
at least one of transmission or reception of image data is enabled between the image processing unit and an external data processing apparatus through VPN connection established on a basis of the result of biometric authentication.

18. The communication system according to claim 16, wherein
when authentication using the data for authentication fails, at least one of information prompting the user to perform detection using the detection unit again or information inquiring whether to switch to authentication different from the authentication using the data for authentication is displayed on a display unit of the image processing apparatus.

19. The communication system according to claim 16, wherein
data for verification to be compared with the data for authentication and account information are downloadable from the server into the image processing apparatus and are storable in the image processing apparatus until a predetermined condition is satisfied.

20. The communication system according to claim 16, wherein
the data for authentication is created by converting the biological information by using data for conversion stored in a storage unit of the image processing apparatus.

21. The communication system according to claim 16, wherein
when data for verification to be compared with the data for authentication in authentication performed by the server is registered in the server, the data for verification based on the biological information detected by a terminal of the user is transmittable from the terminal to the server.

22. The communication system according to claim 16, wherein
at least one of additional registration or replacing registration of data for verification to be compared with the data for authentication in authentication performed by the server is executable for an identical account by a procedure using communication established through authentication different from the authentication using the data for authentication.

23. The image processing apparatus according to claim 1, further comprising
a housing accommodating at least a portion of the image processing unit, the communication unit, and the control unit, the detection unit being integrally located so that the housing covers various wiring connected to the detection unit while exposes the detection unit.
